(19) United States
(12) Patent Application Publication
(10) Pub. No.: US 2004/0262989 A1
(43) Pub. Date: Dec. 30, 2004

(54) Device for electrically locking the brake of an automobile

(76) Inventor: Achawan Atthaprasith, Bangkok (TH)

Correspondence Address: BIRCH STEWART KOLASCH & BIRCH, PO BOX 747, FALLS CHURCH, VA, 22040-0747, US

(21) Appl. No.: 10/819,933

(22) Filed: Apr. 8, 2004

(30) Foreign Application Priority Data
Apr. 11, 2003 (TH) 081719

(51) Int. Cl. B60T 17/16

(52) U.S. Cl. 303/89; 188/265

(57) ABSTRACT

The device for electrically locking the brake of an automobile according to the present invention is a device for theft prevention provided with a system of mechanism for acting on the brake system to stop the wheel from moving and thereby disabling movement of the car. This device is provided with a burglar alarm system for alerting the owner of automobile, persons, or organization concerned by transmitting radio waves to a radio receiver circuit carried by the owner of automobile and instructing the system to make a telephone call to a predetermined number, further including other means of communication. The device for electrically locking the brake of an automobile with execute the locking the brake and informing the owner of automobile, persons, or organization concerned only when the burglar alarm system is activated. In order to prevent or destruction or tampering of the connection of the electrical-electronic circuit including destruction of the components of the mechanism and motor within the braking operation section C1 of the present invention, such components are encased in a metal casing C4 and some parts or the entire structure related to the brake system of the automobile are also covered by metal to prevent destruction of any parts of the brake system until the brake system cannot be used such as cutting of the brake shaft, removing of the brake shaft, etc..

If the motor or mechanism system including the electrical-electronic circuit of the present invention cannot be used then there is an alternative to use a key to unlock the lock release mechanism 21 in order to remove parts or the entire braking operation section C1 from the casing C4, or remove parts or the entire braking operation section C1 including the casing C4 from the brake system attachment base of the automobile, or from the cylinder covering the steering wheel shaft of the automobile, or from the vicinity of the cylinder covering the steering wheel shaft or the brake system attachment base, in order to enable the brake system to function normally.

In addition to preventing stealing of automobiles, this invention can also be used to prevent stealing of various types of vehicle with similar brake system structure to the brake system of an automobile. This can be achieved by designing the motor and mechanism to fit that particular type of vehicle and then applying to the electrical-electronic circuit of the present invention. Such practice allows the device of the present invention to be applied to prevent stealing of various other types of vehicle.

### FIELD OF INVENTION

Electrical and electronic engineering

### BACKGROUND OF INVENTION

Currently there are many types of devices for locking brakes/clutches using only a mechanical system for locking to prevent theft. That is, when a user wants to lock brakes/clutches, he or she can use a hand to pull a moving member of the locking device to press against the brake shaft and clutch shaft, thereby making it impossible to step on the clutch to engage a gear and at the same time disabling the normal use of brake. The thief thus cannot steal the vehicle. However, in reality, modem vehicles use automatic transmission more and more and such vehicles do not have clutches. Therefore, a driver can directly engage the gear, rendering the device for locking brakes/clutches mentioned above ineffective in preventing theft of vehicles using automatic gear. In addition, such locking device lacks convenience of use due to limited and narrow space for installation of the locking device. When the user wants to engage the lock, he or she has to bend down to pull the movable member of the locking device in order to engage the lock. On the other hand, when the user wants to release the lock, he or she still has to bend down to use a key to unlock the lock. This is even more inconvenient during the night or in a parking lot with insufficient lighting to see well. Therefore there is a need to create a new type of locking device for electrically locking the brake of an automobile in this present invention in order to prevent stealing vehicles using ordinary gear shift systems and vehicles using automatic transmissions. Operation of the locking device is much more convenient and not as complicated as the locking device for locking brakes/clutches using a mechanical system only because there is no need to bend down to pull the lock or to bend down to insert a key into the keyhole of the master lock. Moreover, the locking device for locking the brake of an automobile according to the present invention can also works with existing theft prevention systems of previous type already installed on the vehicles.

Moreover, the locking device for locking the brake of an automobile according to the present invention also includes a burglar alarm system and a warning system to alert the vehicle owner of various situations occurring. This increases the efficiency in preventing theft to a level much higher than a locking device for locking brakes/clutches using only a mechanical system.

### OBJECT OF INVENTION

The locking device for locking brakes of a vehicle electrically according to the present invention is a theft-prevention device which is provided with a mechanical system to act on the brake system of a vehicle in order to brake the movement of the vehicle and making the vehicle unable to move; and to provide a burglar alarm system comprising at least a siren for emitting sounds immediately when an abnormal situation arises in order to alert the vehicle owner and attract attention of people nearby. Moreover, a signal for alerting the vehicle owner by sending radio waves to a radio receiver of the vehicle owner plus a telephone call to inform the vehicle owner, persons or organizations concerned to inform such persons of the abnormal situation occurring to the vehicle, including other means of communications capable of sending an alarm signal to the vehicle owner are also included.

The device for electrically locking the brake of an automobile according to the present invention will stop the wheels from rotating and send an alarm signal to the vehicle owner, persons or organizations concerned only when the theft prevention system is activated by detecting an intruder inside the vehicle, which can be carried out by monitoring the temperature, motion in the vehicle, opening of doors, vibration, including various means of detection capable of detecting and signaling an intrusion for stealing. In addition, the device for locking the brakes of a vehicle according to the present invention can also be set into an alarm-ready mode (ARM) or disalarm-ready mode (DISARM) or reset all functions by an encoding basic electronic circuit or encoder IC or encoding with a biometrics system such as encryption using face image, retina, finger prints (BIO-FINGER PRINTING) or other methods of encryption conceivable by persons of ordinary skills of the art within the scope of the present invention. This signaling tool used to set the system into an alarm-ready mode (ARM) or disalarm-ready mode (DISARM) or reset an operation in order to control the operation of the device for electrically locking the brake of a vehicle according to the present invention may be a signaling of code signals directly using wide or wireless remote control, optical systems, radio frequency systems, telephone systems, or other methods of remote control.

Once the operation control section for signaling the device of the present invention sets the system into an alarm-ready mode or disalarm-ready mode or a theft prevention system already installed cannot be used, a TAG (RFID system: radio frequency identification) can be used to reset and cancel all systems into normal state. When the electrical-electronic circuit and driving mechanism according to the present invention cannot be used, a key with unique design can be used to open the lock release mechanism in order to remove the motor and driving mechanism so as to be able to bring the brake system into normal working state.

In addition, the present invention also provides a casing over parts of the whole of the structure related to the brake system of a vehicle using metal materials in order to prevent possible destruction of any parts of the brake system such as by cutting the brake shaft or removing the latch in order to remove the brake shaft, which can make the brake system of the vehicle unable to function, resulting in the disability of the present invention to prevent the stealing of the vehicle.

The first object of the present invention is to provide a prevention of car theft using ordinary transmission and automatic transmission.

Another object of the invention is to provide an apparatus/encoder circuit for setting a system into ready-mode or canceling the ready-mode of the system. Once the apparatus/encoder circuit is encoded, a code signal will be sent to a main control section for processing and operating according to the code signal received. As a result, the operation of the device according to the present invention is more convenient and easier. In addition, if a user of a vehicle installed with a previous kind of theft prevention system, he can also use the device of the present invention together with the existing system.

Another object of the present invention is to eliminate the drawbacks of the locking device for brakes/clutches using only a mechanical system and to enhance the capability and efficiency of the theft prevention system to a higher level than the device of prior arts by providing the mechanism to control the brake system of a vehicle until the vehicle cannot move whenever an abnormal situation arises. Moreover, the present invention also provides a system for alarming the vehicle owner, persons, or organizations concerned by sending radio signal, telephone call, or other means of communications to a receiver carried by the vehicle owner, persons, or organizations concerned in order to inform them of the abnormal situation at the vehicle. The vehicle owner can then take an appropriate action immediately.

Another object of the present invention is to provide a device for locking the brakes of a vehicle which can be used with other types of vehicles besides automobiles. Such vehicles can have a brake structure similar to the brake structure of an automobile. This is made possible by providing a motor and driving mechanism suitable for use in any type of vehicles in order to work with the electrical-electronic circuit according to the present invention. Such operation makes the present invention able to be applied to theft prevention system of many types of vehicles.

### BRIEF DESCRIPTION OF THE DRAWING

FIG. 1 shows a general structure of a brake system of automobile.

FIG. 2 is a block diagram showing an electrical brake system of an automobile working together with a theft prevention system of automobiles already installed.

FIG. 3 is a block diagram of an electrical brake system of an automobile having no theft prevention system previously installed.

FIG. 4 is a flow chart showing a device for electrically locking the brakes of an automobile which can work together with the theft prevention system previously installed in the automobile.

FIG. 5 is a flow chart of a device for electrically locking the brakes of an automobile which can work together with a previous type of theft prevention system already installed.

FIG. 6 is a flow chart showing the operation of a device for electrically locking the brakes of an automobile which is used with an automobile having no previous type of theft prevention system already installed.

FIG. 7 is a flow chart showing the operation of a device for electrically locking the brakes of an automobile which is used with an automobile having no theft prevention system of previous types already installed.

FIG. 8 shows an embodiment of a drive mechanism 18 using an actuator A to react in engaging or releasing the brake.

FIG. 9 shows an internal structure of the drive mechanism 18 as shown in FIG. 8 internally comprising at least a motor M (including also a reduction gear box G), lead screw L, one end of the lead screw inserted to the motor shaft while the other end being inserted into a nut N of a braking member 60 with one end 60a being designed to conform with the brake shaft 19.

FIG. 10 shows an embodiment of the drive mechanism 18 as shown in FIG. 8 being used to engage or release the brake in a direction perpendicular to the brake shaft 19.

FIG. 11 shows an embodiment of the drive mechanism 18 as shown in FIG. 8 being used to engage or release the brakes in a direction not perpendicular to the brake shaft 19.

FIG. 12 shows an embodiment of the drive mechanism 18 shown in FIG. 8 being used to engage or release the brake in a direction not perpendicular to the brake shaft 19.

FIG. 13 shows another embodiment of the drive mechanism 18 comprising at least a pinion P inserted to the shaft of the motor M (including a reduction gear box G) and at the same time being engaged to the rack R, with one end of the rack connected to the brake member 60 having the end 60a designed to conform with the brake shaft 19. Rotation of the motor makes the pinion P rotate to drive direct or to move and carry the brake member 60 into action with the brake shaft 19 in order to engage or release the brake.

FIG. 14 shows an embodiment of the drive mechanism 18 as shown in FIG. 13 being used to engage or release the brakes in a direction not perpendicular to the brake shaft 19.

FIG. 15 shows an embodiment of the drive mechanism 18 as shown in FIG. 13 being used to engage or release the brake in a direction not perpendicular to the brake shaft 19.

FIG. 16 shows an embodiment of the drive mechanism 18 comprising at least a bevel gear B1 arranged to insert into the rotation shaft of the motor M (including a reduction gear box G), a bevel gear B2 attached to the lead screw L inserted into the hole of the nut N. The nut is connected to the braking member 60 with one end 60a designed to conform to the brake shaft 19. Once the motor rotates, the bevel gear B1 also rotates and drives the bevel gear B2 and makes the lead screw L rotate and force the nut N to move and carry the braking member 60 to engage or release the brake.

FIG. 17 shows an embodiment of the drive mechanism 18 comprising at least a cam set S mounted on the rotation shaft of the motor M (including a reduction gear box G). This cam set provides joint P1 for mounting the braking member 60 with one end 60a being designed to conform to the brake shaft 19. Rotation of the motor makes the cam Set follow and make the joint P1 of the cam set S rotate to carry the braking member 60 to engage or release the brake.

FIG. 18 shows an embodiment of the drive mechanism 18 comprising at least a lead screw L mounted to the rotation shaft of the motor M (including a reduction gear box G). The lead screw is inserted into the nut N which is connected to the braking member 60 with one end 60a designed to conform with the brake shaft 19. Rotation of the motor makes the lead screw L rotate and force the nut N to move and carry the braking member 60 to engage or release the brake.

FIG. 19 shows an embodiment of the drive mechanism 18 as shown in FIG. 17, wherein the drive mechanism acts to engage or release the brake in another direction.

FIG. 20 shows an embodiment of the drive mechanism 18 as shown in FIG. 13, wherein the drive mechanism acts to engage or disengage the brake in another direction.

FIG. 21 shows an embodiment of the drive mechanism 18 as shown in FIG. 13, wherein the drive mechanism acts to engage or release the brake in another direction, but the braking member 60 is designed to have a slope as indicated by reference number 61.

FIG. 22 shows another embodiment of the drive mechanism 18 as shown in FIG. 13, wherein the drive mechanism acts to engage or release the brake in another direction, but the braking member 60 is designed to have a slope in another form as indicated by reference number 61.

FIG. 23 shows another embodiment of the drive mechanism 18 as shown in FIG. 18, wherein the drive mechanism acts to engage or release the brake in another direction, but the braking member 60 is designed to have a slope as indicated by reference number 61.

FIG. 24 shows another embodiment of the drive mechanism 18 as shown in FIG. 18, wherein the drive mechanism acts to engage or release the brake in another direction, but the braking member 60 is designed to have a slope in another form as indicated by reference number 61.

FIG. 25 shows another embodiment of the drive mechanism 18 which comprises at least a braking member 60 mounted to the motor shaft M (including a reduction gear box G), at the end of the braking member is provided with a pressing member 62. Rotation of the motor makes the pressing member 62 rotate to act on the brake shaft 19 to engage or release the brake.

FIG. 26 shows another embodiment of the drive mechanism 18 as shown in FIG. 25, wherein the drive mechanism operates to engage or release the brake in another direction.

FIG. 27 shows another embodiment of the drive mechanism 18 comprising at least a pressing member 62 mounted to the rotation shaft of the motor M (including a reduction gear box G). Rotation of the motor makes the pressing member 62 rotate to act upon the brake shaft 19 to engage or release the brake.

FIG. 28 shows another embodiment of the present invention when a key is used to release the lock release mechanism 21 in order to remove the motor M, the lock release mechanism 21, and parts or the entire drive mechanism 18 and the casing C4 which is made from metal, in case the motor M, drive mechanism 18, or the electrical-electronic circuit of the present invention does not function.

FIG. 29 shows another embodiment of the present invention when a key is used to release the lock release mechanism 21 in order to remove the motor M, the lock release mechanism 21, and parts or the entire drive mechanism 18 out of the casing C4 which is made from metal, in case the motor M, drive mechanism 18, or the electrical-electronic circuit of the present invention does not function.

FIG. 30 shows another embodiment of the TAG 7 which has a different form.

FIG. 31 systematically shows another embodiment of the lock release mechanism 21 and a structure for installing a brake operation section C1 encased in a casing C4 of the present invention, of the steering wheel shaft cylinder (31A). FIG. 31B shows an operation to assemble the lock release mechanism 21.

FIG. 32 systematically shows another embodiment of the lock release mechanism 21 and a structure for mounting the breaking operation section C1 encased in a casing C4 of the present invention to a brake base 51 in FIG. 32A. FIG. 32B shows how the lock release mechanism 21 is assembled together.

FIG. 33 systematically shows another embodiment of the lock release mechanism 21 and a structure for mounting the breaking operation section C1 encased in a casing C4 of the present invention to the brake base 51 in FIG. 33A. FIG. 33B shows how the lock release mechanism is assembled together. FIG. 33C shows how the master lock 73 operates to engage or release the lock.

FIG. 34 systematically shows another embodiment of the partial or total encapsulation of all the structure related to a brake system of an automobile using a cylinder 57 made from metal (34J).

FIG. 35 systematically shows another embodiment of the encapsulation of parts or the whole of the structure related to the brake system of an automobile using a cylinder 58 made from metal (35L).

### DETAILED DESCRIPTION OF THE INVENTION

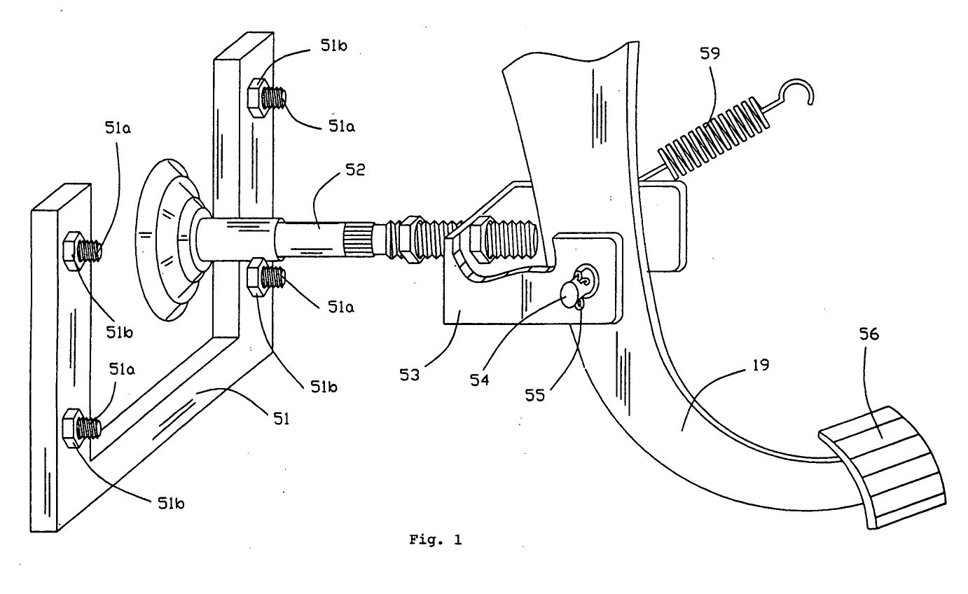

In order to help facilitate the understanding of the operation of the device for electrically locking the brake of an automobile of the present invention, an explanation of the general structure of the brake system of an automobile as shown in FIG. 1 comprising at least a brake base 51 for attaching the brake system to the body of the automobile will be detailed. A brake shaft 52 protruding from the engine room into the interior of the automobile is arranged to work together with the brake shaft 19 using a U-shape attachment structure 53. The latch shaft 54 and lock pin 55 work in such a manner that when there is a force acting on the brake pedal 56, the brake shaft 19 will move to press the brake shaft 52 and causing an engagement of the brake over the wheel which renders the automobile unable to move.

The device for electrically locking the brake of an automobile according to the present invention comprises a brake operation section C1, a main control unit C2, instruction section C3, antenna coil 6, TAG 7, and a key 22. The feature and operation of each of these parts mentioned above will be described below.

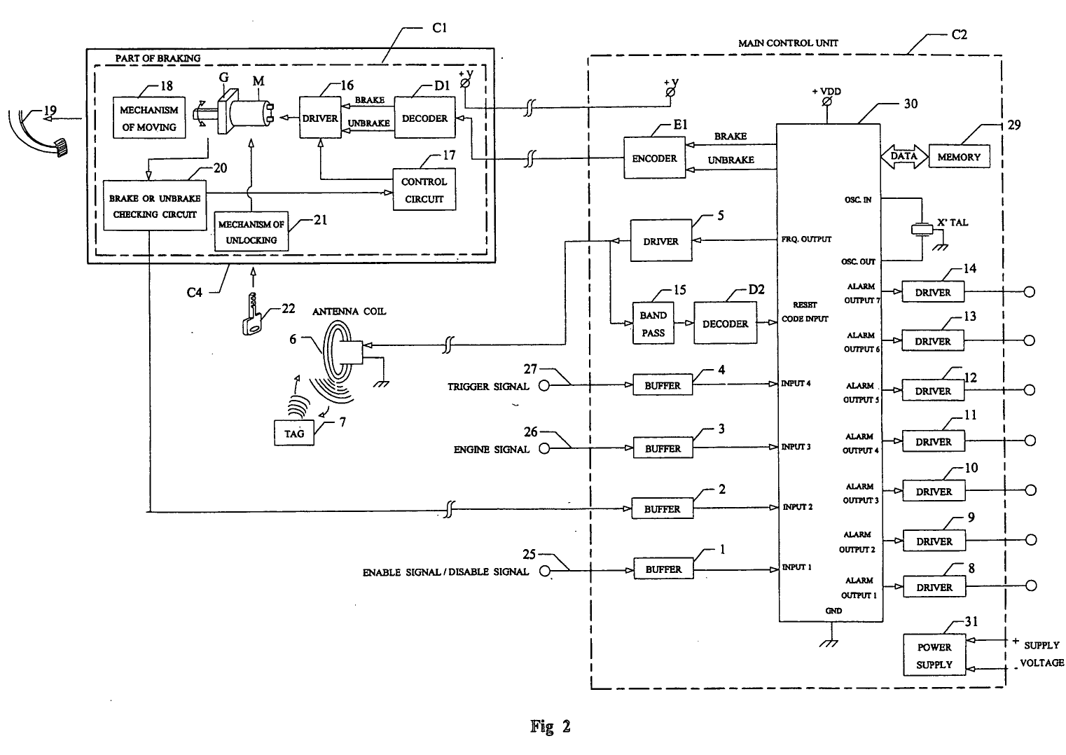

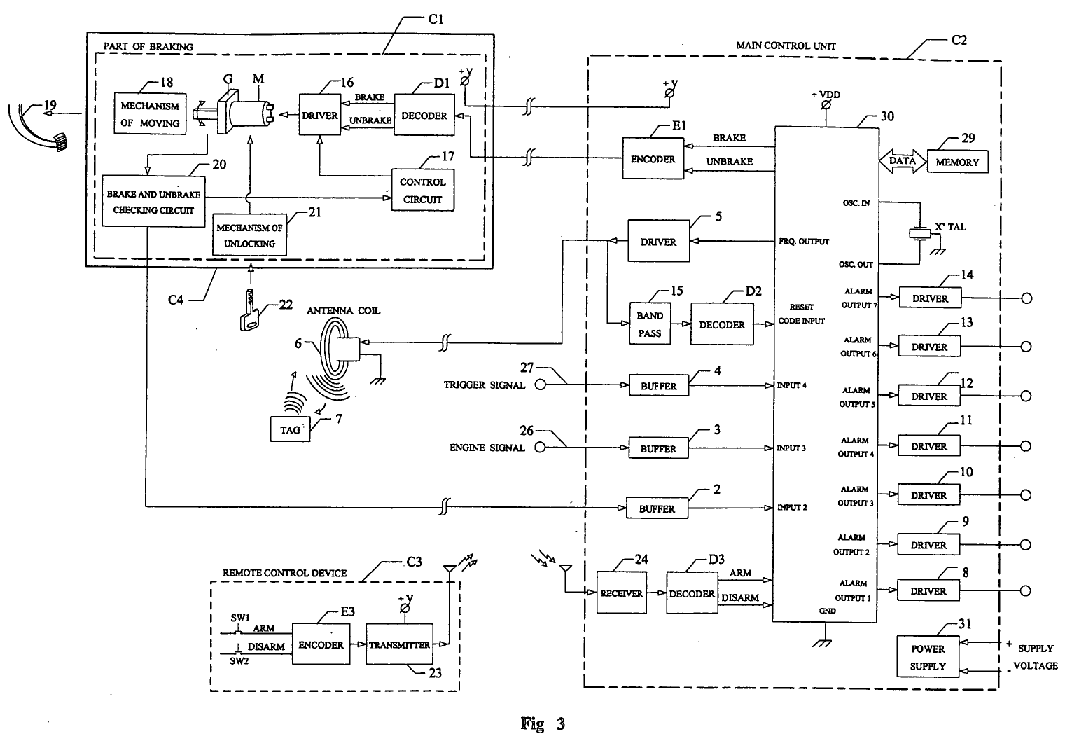

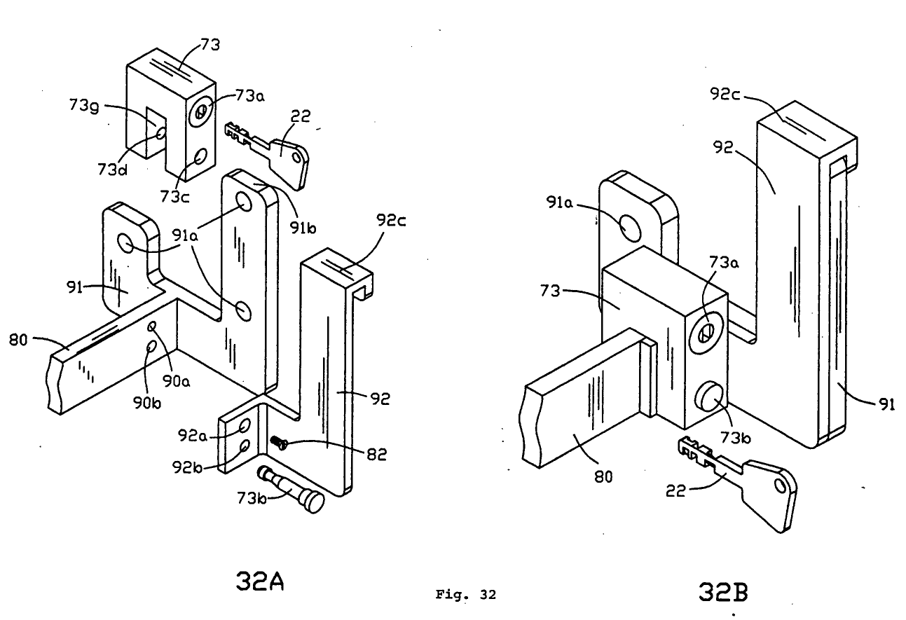

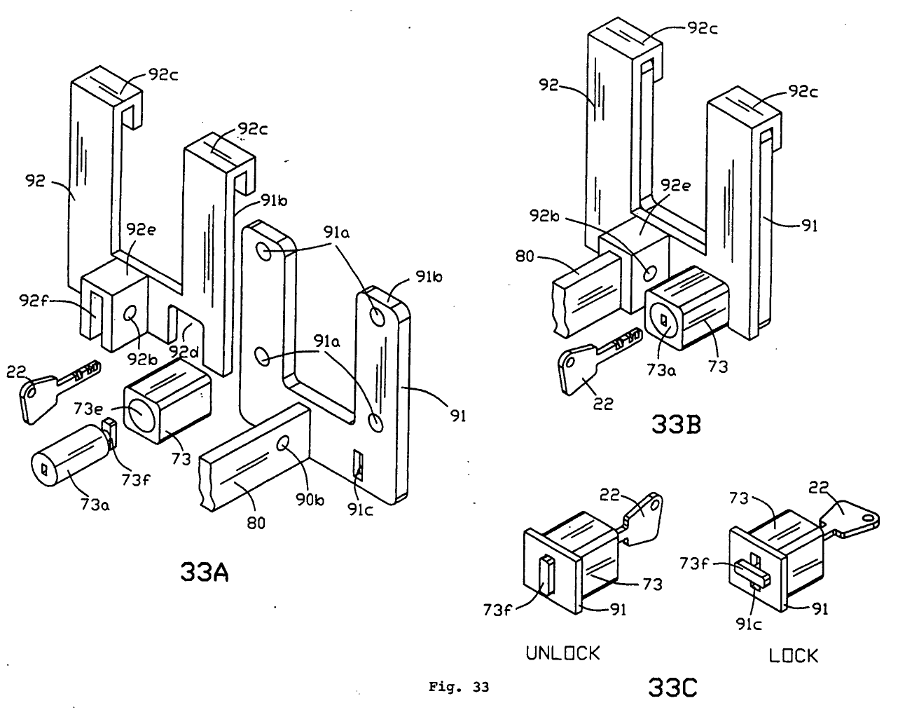

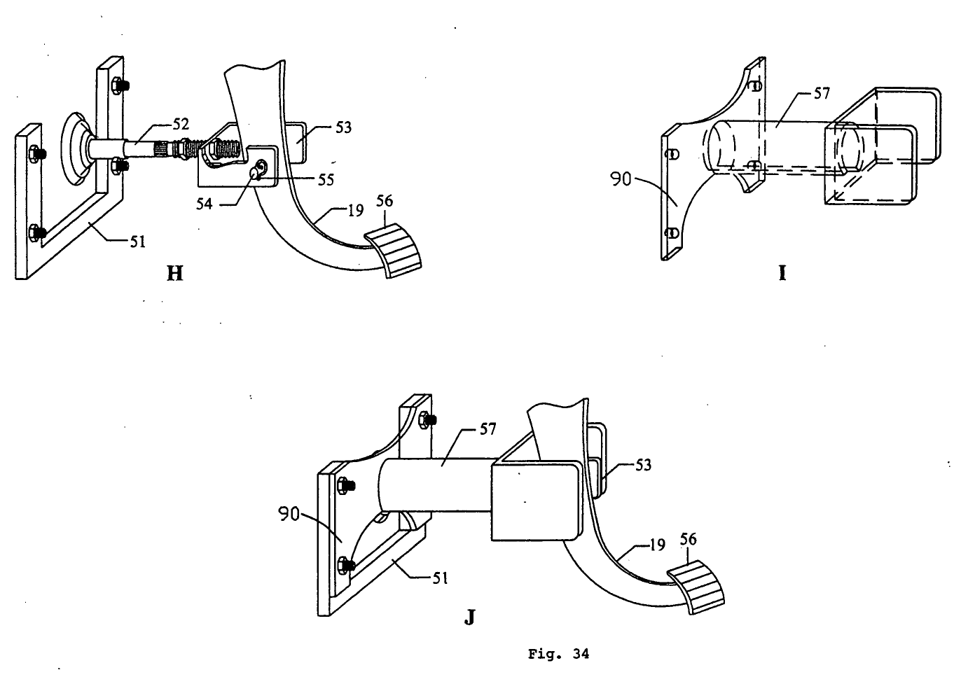

The brake operation section C1 as shown in FIG. 2 and FIG. 3 is an important part in a braking operation which includes at least a decoder circuit D1, driver circuit 16, control set 17, motor M (including a reduction gear box G), drive mechanism 18 for engaging or releasing the brake, a detection circuit 20 for detecting the engaged and released conditions of the brake, and a lock release mechanism 21. These components are assembled together in case solidly in a casing C4 made from metal to prevent any attempt to destroy the drive mechanism 18, lock release mechanism 21 and motor M along with the prevention of the destruction or the tampering of the electrical-electronic circuit connection such as short circuiting using a wire to connect a power source directly to the motor in order to force the drive mechanism to move and release the brake so that the car can be used normally. After the brake operation section is completely encased in the casing, it will be installed solidly to cylinder covering the steering wheel shaft (see FIG. 31), or mounted to the brake base 51 (see FIG. 32 and FIG. 33), or installed close to the cylinder covering the steering wheel shaft or brake base, depending on the model of the automobile and the selection of the drive mechanism used to engage or release the brake.

The brake releasing mechanism 21 mentioned above is another important part of the present invention which is provided to help releasing the brake of an automobile back into normal working conditions when the motor M or the drive mechanism 18 or the electrical-electronic circuit of the present invention cannot function. In other words when such situation occurs it is possible to use a key 22 to unlock the master lock 21 in order to remove the motor M, lock release mechanism 21, and drive mechanism 18 from the casing C4. In addition to assembling the lock release mechanism 21 together with other components and then encasing in a casing C4 made from metal as described above, the lock release mechanism 21 can also be assembled to outside the casing C4. Such installation makes it possible to release the brake of an automobile back to normal working conditions. When the motor M or drive mechanism 18 or electrical-electronic circuit of the present invention do not function, it is possible to use a key 22 to unlock the master lock 21 in order to release part of the whole of the brake operation section C1 including the casing C4 from the brake base 51 or the cylinder covering the steering wheel shaft, or detaching from the area close to the cylinder covering the steering wheel shaft, or detaching from the area close to the brake base, such operation will be described below.

The operation of the brake operation section C1 mentioned above is in such a manner that when the decoder circuit D1 received a signal from the encoder circuit E1 transmitted from the main control section C2, a comparison will be made between the said code signals and a predetermined code for matching. If the codes match, then a signal will be sent to the drive circuit 16 to convert the signal obtained into an appropriate form or level to drive the motor M. Once the motor M receives the signal from the drive circuit 16, it will rotate to force the drive mechanism 18 to act on the brake shaft 19 or other parts of the brake system (not shown in the figures) in order to engage or release the brake. While the motor is rotating, the detection circuit 20 for detecting the engaged and released conditions of the brake will monitor the rotation position of the motor M or the position of the movement of the drive mechanism 18 or the position of the brake shaft 19 to determine whether these parts are in complete engaged or released conditions. If the position is not a completely released or engaged position, the detection circuit 20 then sends a signal to the control circuit 17 to carry out the processing and send a control signal to the driver circuit 16 in order to force the motor M until the brake system is in a fully engaged or released condition. When the brake system is in such condition, the detection circuit 20 then sends a signal to a buffer circuit 2 in order to cause the main control section C2 to carry out the rest of the work.

The present invention can use a microcontroller or integrated circuit (IC) specially designed to replace the decoder circuit DI, drive circuit 16, control circuit 17, detection circuit 20. Such modification is considered to be within the scope of the present invention.

The main control unit C2 comprises at least a microcontroller 30 for functioning as a center for processing and instructing the device for electrically locking the brake of automobiles to function. For a better understanding of the operation of the microcontroller 30 an explanation will be given in conjunction with FIG. 2 and Block Diagram of the operation of the present invention working together with a previous type of theft prevention system already installed.

The microcontroller 30 will receive a signal through an input terminal for processing and send an output signal to control the operation of related devices or circuits through an output terminal. An ENABLE signal 25 or DISABLE signal 25 from the theft prevention system already installed in the automobile is received via a buffer circuit 1 in order to adjust the signal to an appropriate level and then transmit into an input terminal 1 of the microcontroller 30 for processing in order to set the device into an alarm-ready mode (ARM) or a cancel alarm-ready mode (DISARM).

A theft prevention system of previous type already installed according to the present invention means a burglar alarm system or a burglar prevention system used to control the locking or unlocking of the doors of an automobile, including control of the operation of other parts of an automobile. Setting the system into an alarm-ready mode (ARM) in the theft prevention system of previous type will render the automobile enable to function normally. The signal generated from such setting of system is used as an ENABLE signal 25 of the present invention. Setting the system into a DISARM mode of the theft prevention system of previous type already installed will make the automobile able to function normally. The signal generated from such action is used as a DISABLE 25 of the present invention. Such signals can be obtained from a siren, light bulb or flashing light bulb of the automobile, LED, a signal to lock or unlock the doors of the automobile, etc.

The buffer circuit 2 is provided to receive signals from the detection circuit 20 for detecting the engaged or released condition of the brake which is sent from the braking operation section C1 into the input terminal 2 of the microcontroller for processing and instructing according to the sequence in the flow chart.

An engine signal 26 according to the present invention means a signal received from turning the ignition key of the automobile to the ON position or starting position, signals obtained from measurement of engine revolution, signals generated from changes in the level of the lubrication oil in the engine, signals obtained from the ignition in the cylinder, interference signals generated in the positive (+) cable and negative (−) cable of the battery of an automobile which is distributing electrical charges to various parts of the automobile while the engine is working, signals obtained from supplying of fuel, signals obtained when starting the engine, including other signals obtained after the engine has started to rotate. The engine signal 26 is transmitted via the buffer circuit 3 for adjustment of the signal to an appropriate level and then sending through an input terminal 3 of the microcontroller in order to allow the microcontroller to carry out the processing and instruction according to the sequence of the operation.

The activation signal 27 is a signal obtained from a detection whether a risk of an intruder in the automobile or not by monitoring the temperature, motion in the automobile, opening of doors, vibration of the automobile, including other means of detection which enable detection of intrusion for the purpose of stealing. Such activation signal 27 forced into the buffer circuit 4 for adjustment of the signal to an appropriate level and then sending through the input terminal 4 of the microcontroller so that the microcontroller can carry out processing and instruction according to the sequence of work.

A band pass circuit 15 receives an ID (IDENTIFICATION CODE) code signal mixed with radio waves sent from TAG 7 via an antenna coil 6. The band pass circuit 15 will filter the ID code signal mixed with the radio waves (RF) and then adjust the signal into a complete form before sending to the decoder circuit D2 so that the decoder circuit D2 can compare the ID code signal received with a predetermined code to determine whether the ID code received is correct. If it is determined that the ID code is correct, then a signal will be sent to a Reset Code Input terminal (RESET) of the microcontroller in order to reset all operations of the device for electrically locking the brake of an automobile according to the present invention, to bring the system back to normal state and enable the brake system of the automobile to return back to normal operating conditions.

The drive circuit 5 is a circuit for amplifying the frequency signal sent from the FRQ.output terminal of the microcontroller 30 and for formatting the signal into an appropriate form before sending to the antenna coil 6.

The band pass circuit 15, decoder circuit D2, drive circuit 5, antenna coil 6, and TAG 7 mentioned above are parts used for encoding and decoding called RFID.TRANDSPONDER which operates to reset all operations of the present invention back into a normal working condition. In order to enable the brake system of an automobile to operate normally, these parts are assembled together, the system is set to work in such a manner that once the device of the present invention has engaged the brake until the automobile can no longer move, the microcontroller 30 will carry out processing and send a signal to an alarm output terminal in order to control various functions (as will be described later) at the same time as to transmit radio frequency to the FRQ.OUTPUT terminal for supplying to the drive circuit 5 provided for amplifying and formatting signals into an appropriate form and then sending such signals to the antenna coil 6 so that the antenna coil 6 can distribute the frequency wave energy for generating energy to TAG 7 into the air. Once TAG 7 with a ID code approaches the frequency wave energy, it can then create energy for itself. This makes it possible for TAG 7 to generate an ID code for a mixing (MODULATE) with the radio wave in itself and then send the code signal back to the antenna coil 6. The signal received by the antenna coil 6 is then forwarded to the band pass 15 for filtering and adjustment into a complete signal and then sent to the decoder circuit D2 for determining whether the code signal obtained matches the predetermined code or not. If a match is detected, then a signal will be sent to the RESET CODE INPUT terminal of the microcontroller 30 for processing and resetting all operations of the device of the present invention and thereby returning the brake system back to a normal operation condition.

The encoder circuit E1 is a circuit provided for receiving signals for engaging or releasing the brake from the microcontroller and then determining a code signal for sending to the decoder circuit D1 in the braking operation section C1 according to the sequence of work.

The ALARM OUTPUT terminal is a terminal of the microcontroller provided for sending an instruction OUTPUT to carry out various functions. The number of such ALARM OUTPUT terminals is not limited to any specific number and can be any number considered appropriate for each type of applications. Shown in FIG. 2 and in FIG. 3 are 7 ALARM OUTPUT terminals as an example for easy understanding and not pass a limitation to the scope of the present invention. According to the figures, the signal sent via the ALARM OUTPUT terminal 1 to ALARM OUTPUT terminal 7 will be amplified and formatted for each specific output to suit each type of functions by the drive circuit 8 through the drive circuit 14. Each output has the following functions.

ALARM OUTPUT 1 is for controlling the operation of siren (not shown) so that the siren can send a sound immediately to alert the owner of the automobile of the emergency and attract attention of people nearby.

ALARM OUTPUT 2 is for sending an alarm signal to the owner of the automobile to inform the owner of the situation occurring with the automobile by sending radio wave to a radio wave receiver carried by the owner of the automobile (not shown in the figures).

ALARM OUTPUT 3 is for sending an alarm signal to the owner of the automobile, persons, or organizations concerned to inform them of the abnormal situation occurring with the automobile by instructing the system to make a telephone call to a predetermined telephone number or by other means of communications (not shown in the figures) in case the owner of the automobile, persons, or organizations concerned are located far from the automobile.

ALARM OUTPUT 4 is for inhibiting the electrical system of the ignition system of the automobile from normal operation (not shown in the figures).

ALARM OUTPUT 5 is for controlling the operation of the light bulbs of the automobile to flash (not shown) in order to send an alarm signal to the owner of the automobile as well as to attract the attention of people nearby.

ALARM OUTPUT 6 is for controlling the operation of the engine (not shown) so that the electrical system does not facilitate the engine operation such as ECU (ENGINE CONTROL UNIT), fuel supply system.

ALARM OUTPUT 7 is a reserved channel for controlling the operation of various components of the automobile. It is also reserved for working together with theft prevention system of other types.

X'TAL is for generating frequency OSC. for the microcontroller in order to enable the operation.

Power supply 31 is for supplying electrical current to various circuits in the main control section C2, the braking operation section C1, and

Memory 29 is for storing data and programs for controlling the device of the present invention.

FIG. 3 is a block diagram of the present invention which has been installed on an automobile having no theft prevention system of previous types already installed. The device includes an instruction section C3 for setting the system into an alarm-ready mode (ARM) or cancel alarm-ready mode (DISARM) comprising at least a device for connecting or disconnecting signals flow which can be a switch SW1 and switch SW2, encoder circuit E3, signal transmission section (Tx) 23. When these components are assembled together, they will enable the instruction section C3 to operate and in such a manner that switch SW1 is pressed, the encoder circuit E3 will send an ID code signal and a ARM instruction to the signaling section (Tx) 23 in order to transmit the said signal to the signal receiving section (Rx) 24 in the main control section C2 so as to set the system into a ready mode; or when the switch SW2 is pressed, the encoder circuit E3 will transmit an ID code signal and a DISARM instruction to the signaling section (Tx) 23 to send a signal to a signal receiving section (Rx) 24 in the main control section C2 in order to cancel the ready mode and then cancel all operations of the device of electrically locking the brake of an automobile according to the present invention. This brings the brake system of an automobile back to a normal working condition.

The switch SW1 and switch SW2 mentioned above may be one single switch for setting the system into a ready mode or canceling the ready mode in such a manner as pressing the switch the first time will set the system into ARM mode and pressing the switch a second time will set the system into DISARM mode, and pressing the switch a third time will set the system back into ARM mode, and so on.

The main control section C2 as shown in FIG. 3 provides a receiving section (Rx) 24 and a decoder circuit D3 for receiving an ARM signal or a DISARM signal from the instruction section C3. That is, the receiving section (Rx) 24 obtains an instruction signal from the instruction section C3 and then sends that signal to the decoder circuit D3 in order to let the decoder circuit verify the ID code signal received for matching with a predetermined code, before sending a signal to the microcontroller. If the ID code matches and a ARM instruction is received, then the microcontroller will carry out the processing and give instruction to the device of the present invention to set the system into a ready mode. On the other hands, if the instruction is a DISARM instruction, then the microcontroller will process the signal and give an instruction to cancel the ready mode and cancel all operations of the device in order to return the brake system of the automobile back to a normal operating condition.

In the control section C2 as shown in FIG. 2 and FIG. 3, the encoder circuit E1, the decoder circuit D2, decoder circuit D3, memory unit 29 can be incorporated into the microcontroller 30, depending on the design of the operating software and type of microcontroller used.

The device for locking the brake of an automobile according to the present invention as shown in FIG. 3 provides an encoder circuit E3 within the instruction section C3 for setting the system into a ready mode (ARM) or canceling the system from the ready mode (DISARM). The encoding method may be an encoding method using a basic electronic circuit or a ready-made encoding IC or a biomatrics encoding system (such as bio-finger printing, face scan, retina scan, etc.) or by using a smart card or a card with a specific bar code or a citizen identification card of a smart card type or other means of encoding which enable the main control section C2 to process and give instruction to related parts to carry out the operation or cancel the operation. Persons of ordinary skills in the art can carry out the work using such methods and are not considered to be outside of the scope of the present invention. In case of resetting all operations of the present invention, such methods can be used to reset all operations besides using TAG 7.

Transmission of the code signal to the main control section C2 may be a direct wired transmission of code signal or a wireless transmission such as optical transmission, radio frequency transmission (RF), television signal transmission, remote control transmission, or other means of transmission which can cause a transmission of signals obtained from encoding to the decoder circuit in the main control section C2 in order to allow the main control section to carry out processing and issuing instruction to related parts to operate according to the code signal received. This is not considered to be departing from the scope of the present invention.

The antenna coil 6 is provided for receiving frequency signal from the FRQ.OUTPUT of the microcontroller via the drive circuit 5 for distributing frequency wave energy for generating energy to supply to TAG 7 into the air and receiving an ID code signal from TAG 7 and then send to the main control section C2 for execution according to the sequence of operation.

The TAG 7 which is also called TRANSPONDER which operates by receiving energy from the antenna coil 6 for generating the energy to itself and generating an ID code for mixing the ID code with the radio wave within itself and then sending the code signal back to the antenna coil 6. The outer appearance of TAG 7 can differ in terms of shape and features such as shown in FIG. 30 as an example. Regardless of its shape, TAG has a unique ID code and therefore TAG is a type of encoding device having a large of codes available.

A key 22 has a unique feature for use with the device for electrically locking the brake of an automobile. This key is provided for unlocking the lock 21 in order to remove the motor M and the lock release mechanism 21 out from the casing C4, or in order to remove some parts or all of the breaking operation section C1 out from the brake attachment base 51 or the cover cylinder of the steering wheel shaft or from the vicinity of the cylinder covering the steering wheel shaft of the attachment base of the brake system, in case the motor, drive mechanism, or electrical-electronic circuit of the present invention do not function, so that the driver of the automobile can release the brake and return back to normal operating condition and be able to drive the car normally.

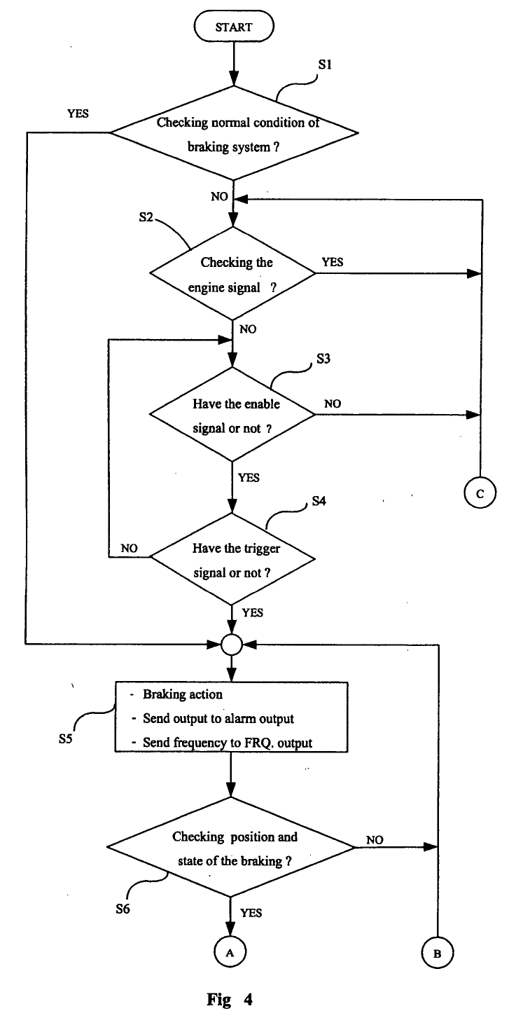

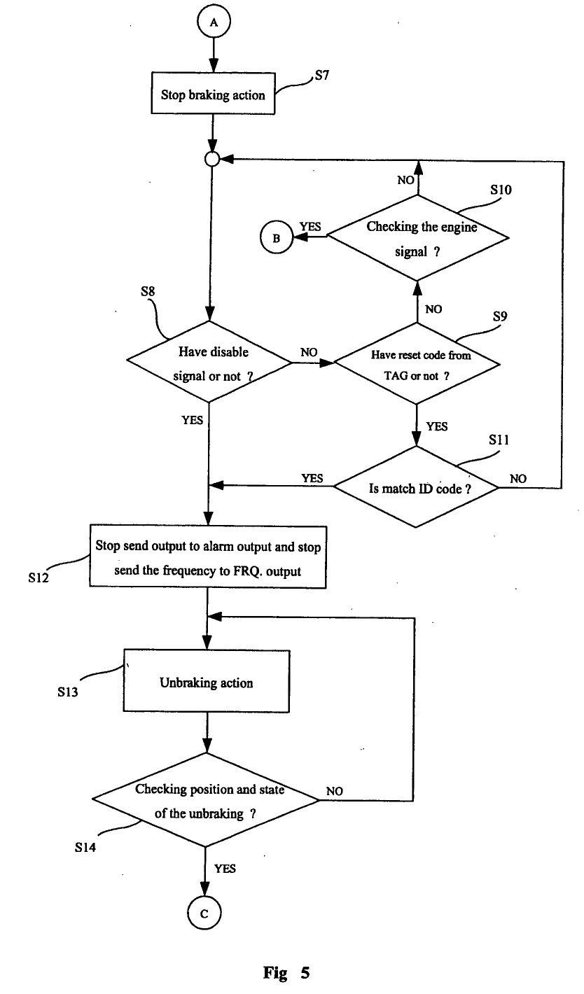

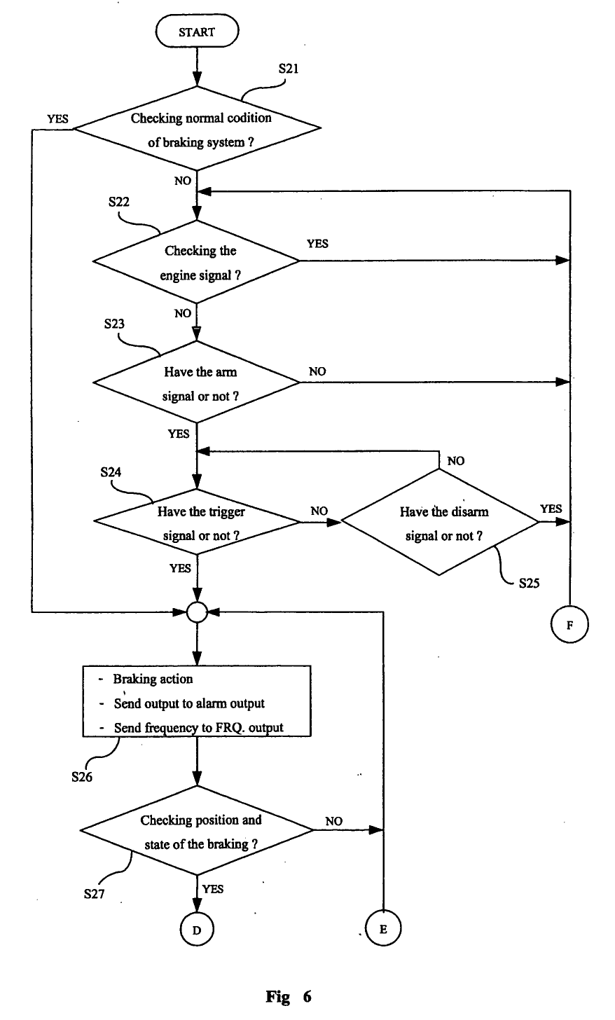

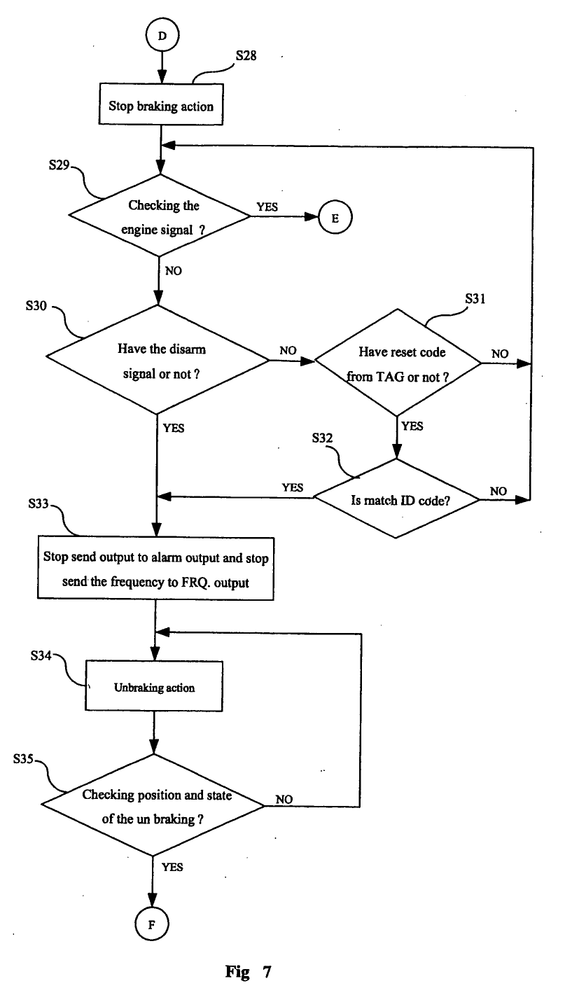

To help facilitate the understanding of the flow chart illustrating the operation sequence of the device for electrically locking the brake of an automobile, an explanation of the sequence of the operation will be given in the following two manners: sequence of operation of the device for electrically locking the brake of an automobile when working together with a theft prevention system of previous types already installed as shown in FIGS. 4 and 5, and a sequence of work of the device for electrically locking the brake of an automobile which is used with an automobile having no theft prevention system already installed as shown in FIGS. 6 and 7.

FIGS. 4 and 5 show a sequence of work of a device for locking brake of an automobile when used to work together with a theft prevention system of previous types already installed. The sequence of work comprises a step SI in which the device for electrically locking the brake of an automobile will check the existence status of the brake system of the automobile at that time whether the brake is engaged or not by using a brake status checking circuit 20 to check such status and send a signal to an INPUT TERMINAL 2 to the microcontroller 30. If the brake of the automobile is engaged, then the operation proceeds to step S5 to confirm that the engagement of the brake really stop the car from moving. On the other hand, if at that moment, the automobile's brake is in a released condition, then the operation proceeds to step S2 for checking whether the engine is working or not by monitoring the engine signal 26 sent from the INPUT TERMINAL 3 of the microcontroller 30. If that moment there is a signal indicating that the engine is working, then the microcontroller according to the present invention will carry out the processing and issue an instruction not to do anything to ensure that no braking of the automobile is done while driving, which help prevent any possible accident. On the other hand, if at that moment, there is no signal indicating the engine is working, then the microcontroller according to the present invention will carry out a processing and proceeds to step S3 to check whether there is an ENABLE signal 25 coming into the INPUT TERMINAL 1 of the microcontroller 30 or not. If there is an ENABLE signal 25, then the operation returns to the step S2 again. If an ENABLE signal 25 is detected, then the operation proceeds to step S4 to check whether there is an activation signal 27 passing into INPUT TERMINAL 4 of the microcontroller 30. If no activation signal 27 is present, then the operation returns to step S3 again. On the other hand, if an activation signal 27 is present and pass into the microcontroller 30, then the operation proceeds to step S5. That is, the encoder circuit E1 from the main controller section C2 will transmit a braking instruction signal to the breaking operation section C1 in order to engage the brake of the automobile. The microcontroller 30 sends an instruction output to the alarm output terminal 1 through the alarm output terminal 7. Each output is amplified and formatted to an appropriate level and form suitable for the operation in each function by the drive circuit 8 through the drive circuit 14 for further execution as described above. A frequency is also sent to the FRQ.OUTPUT terminal of the microcontroller 30 to the drive circuit 5 for amplifying and formatting the signal to a level and form suitable for outputting to the antenna coil 6 for distributing the frequency wave energy into the air for supplying the energy to TAG 7.

After completing step S5, then the operation proceeds to step S6 for checking the position and status of the brake whether the status is complete or not. If it is not in a fully braked status, then the operation returns to step S5 again to make sure that the system has entered a fully braked condition. Once it is confirmed that the braking position and status are complete, then the braking operation is stopped at step S7 (FIG. 5) which is continuing from A in FIG. 4. The operation then proceeds to step S8 for determining whether there is a DISABLE signal 25 from the theft prevention system of previous types already installed transmitted to the microcontroller 30 or not. If no DISABLE signal is present, then the operation proceeds to step S9. On the other hand, if there is a DISABLE signal 25 present in the microcontroller, then step S12 is executed. The operation is step S9 is for checking there is an ID code signal from the decoder circuit D2 passing through the RESET CODE INPUT of the microcontroller 30 or not. Such signal is obtained by having a ID code signal sent from TAG 7 to the band pass circuit 15 for filtering and formatting the code signal into a complete form and then sending to the decoder circuit D2 for determining whether the code signal obtained matches a predetermined code or not. If there is no ID code signal passing in, then the operation proceeds to step S10 for checking whether there is an attempt to make the engine work or not (by detecting an engine signal 26). If there is an attempt to make the engine work, then the operation returns to step S5 again. On the other hand, if there is no attempt to make the engine work, then the operation returns to examine the DISABLE signal 25 according to step S8. If in step S9, there is an ID code signal from TAG 7 passing in, then step S11 is executed by examining the ID code received from TAG 7 whether the ID code received matches a predetermined code or not. If the ID code does not match, then the operation returns to step S8 again. However, if the ID code received from TAG 7 is correct, then step S12 is executed by having the microcontroller 30 carry out and processing cancel and reset all the operations of the device of the present invention back to a normal state. The sequence of operations is as follows: stop sending instruction output to the ALARM OUTPUT 1 through ALARM OUTPUT 7 and then stop sending frequency to the FRQ.OUTPUT terminal. The operation then enters step S13 in which the microcontroller 30 transmits a signal for releasing the brake to the encoder circuit E1 so that the encoder circuit can create a signal which is a code for releasing the brake and then send to the braking operation section C1. The breaking operation section C1 then releases the brake back to a normal working state. In order to ensure that the device of the present invention releases the brake back to a normal state, the position and state of disengagement of the brake is examined by braking and releasing state detection circuit 20 in step S14. If such position or state is not a position or state of brake release which is correct, then the operation returns to step S13 again. On the other hand, if it is a current position or state or break release, then the operation returns to examine the operation of the engine in step S2 (as shown in FIG. 4 in continuation from C in FIG. 5).

FIGS. 6 and 7 show a sequence of operation of the device of the present invention when used with an automobile having no theft prevention system of previous types already installed. Steps of operation are as follows. In step S21, the device of the present invention will examine the existing state of the brake system of the automobile whether it is in a braked or released state. The brake engaged and released state detection circuit 20 operates to examine such state of operations and then sends a signal to the INPUT TERMINAL 2 of the microcontroller 30. If at the moment the automobile is in a braked engaged state, then the operation proceeds to step S26. On the other hand, if the automobile is in a brake release state, then the operation proceeds to step S22 to determine whether the engine signal 26 sent to the INPUT TERMINAL 3 of the microcontroller 30 is present. If the engine signal is present, then the microcontroller 30 according to the present invention will carry out a processing to instruct the system not to do anything at all to ensure the user that no braking will be exercised at all while driving the vehicle, which helps prevent possible accident. If on the other hand no engine signal is present and the operation proceeds to step S23 to check whether the system is set into a ready mode (ARM) from the instruction section C3 into the microcontroller 30 or not. If there is no ARM signal coming in, then the operation returns to step S22 again. On the other hand, if there is an ARM signal coming in to the microcontroller 30, then step S24 is executed to check whether there is an activation signal 27 coming into the INPUT terminal 4 of the microcontroller 30 or not. If step S24 shows that there is no activation signal 27 coming in, then step S25 is executed to check whether there is a cancellation and resetting of the system from ready mode (DISARM) or not. If there is a DISARM signal from the instruction section C3 coming into the microcontroller 30, then the operation returns to step S22. If no DISARM signal is detected, then the operation returns to step S24. If in step S24 it is determined that there is an activation signal 27 coming into the INPUT TERMINAL 4 of the microcontroller 30, then the operation proceeds to step S26. That is, the encoder circuit E1 from the main control section C2 will send a braking instruction code signal to the braking operation section C1 in order to brake the automobile. The microcontroller 30 sends an instruction output out to the ALARM OUTPUT 1 through ALARM OUTPUT 7. Each output is amplified and formatted into a form suitable for each function by the drive circuit 8 through drive circuit 14 in order to carry out further executions as described above. A frequency is also sent out to the FRQ.OUTPUT terminal of the microcontroller 30 and transmitted to the drive circuit 5 for amplifying and formatting of the signal into an appropriate form before sending to the antenna coil 6 so that the antenna coil can distribute the frequency wave energy for supplying energy to the TAG 7 into the air.

After the step S26 is completed, then the operation proceeds to step S27 to determine whether the system is in a fully engaged brake position and state or not. If the brake is not fully engaged, then the operation returns to step S26 again to ensure that the brake is fully engaged. Once it is determined that the system is in a fully engaged brake position and state, then the braking operation is stopped in step S28 (FIG. 7) which is continuing from D in FIG. 6. After that step S29 is executed to check whether there is an attempt to make the engine operate or not (by monitoring an engine signal 26) coming in to the INPUT TERMINAL 3 of the microcontroller 30. If at that moment an engine signal is present to indicate that the engine is operating, then the operation returns to step S26. On the other hand no engine operation signal is present, then step S30 is executed to check whether there is a cancellation and resetting of the system (DISARM) from the instruction section C3 coming into the microcontroller 30. If no DISARM signal is coming into the microcontroller 30, then step S31 is executed. If a DISARM signal is present, then step S33 is executed. In the execution of step S31, the system will determine whether there is a signal coming into the reset code input terminal of the microcontroller 30. Such signal comes from an event in which TAG 7 sends an ID code signal into the band pass circuit 15 in order to filter and adjust the code signal into a complete form and then send it to the decoder circuit D2 for determining whether the code signal received matches a predetermined code or not. If there is no ID code signal into the reset code input terminal of the microcontroller 30, the step S29 is executed to check whether there is an attempt to make the engine work or not (by checking the engine signal 26). If there is an ID code signal from TAG 7 coming in, then step S32 is executed to examine whether the ID code matches a predetermined code or not. If the ID code does not match, then return to step S29. On the other hand, if the ID code received from TAG 7 is correct, then step S33 is executed to allow the microcontroller 30 to reset and cancel all operations according to the following sequence: Stop sending instruction output to the ALARM OUTPUT TERMINAL 1 through ALARM OUTPUT TERMINAL 7 and stop sending frequency to FRQ.OUTPUT terminal and then proceed to step S34 in which the microcontroller 30 will transmit a signal for releasing the brake to the encoder circuit E1 so that the encoder circuit can create a signal to be used as a code for sending to braking operation section C1 so as to release the brake of the automobile back to a normal working condition. In order to ensure that the device of the present invention has disengaged the brake back to a normal working condition, an examination of the position and state of the brake releasing is carried out by a brake engaged and released state detection circuit 20 in step S35. If such position and state is not a correct position or state of the brake release then the operation return to step S34 again. On the other hand, if the position and state is a correct position or state of the brake release, then the operation returns to check the operation of the engine in step S22 (as shown in FIG. 6 continuing from F in FIG. 7).

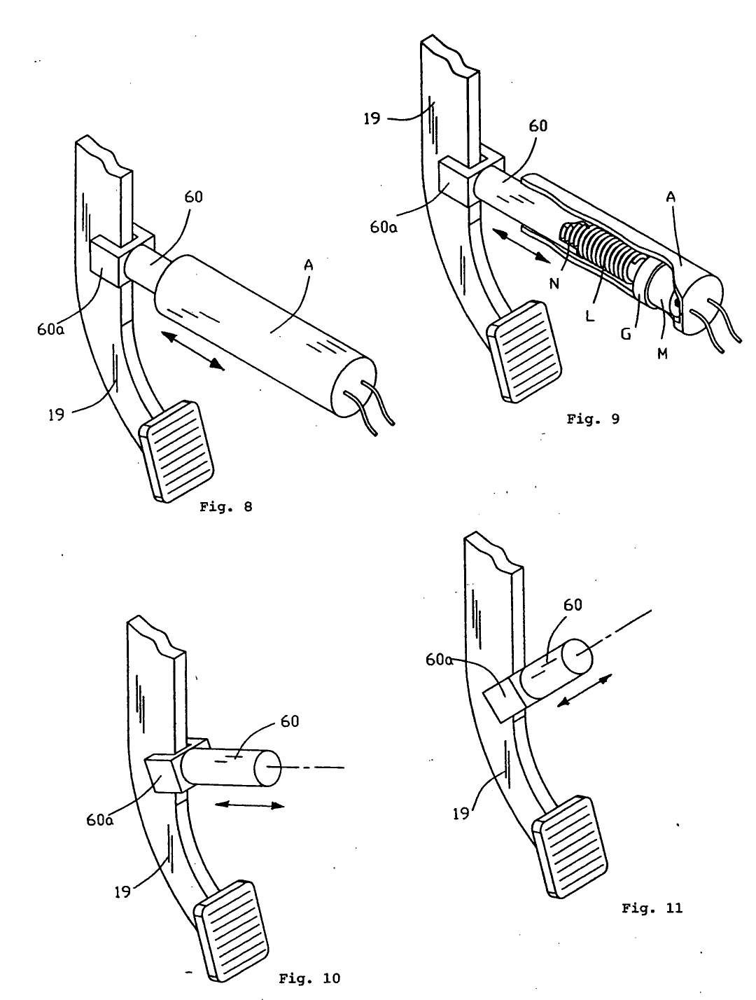

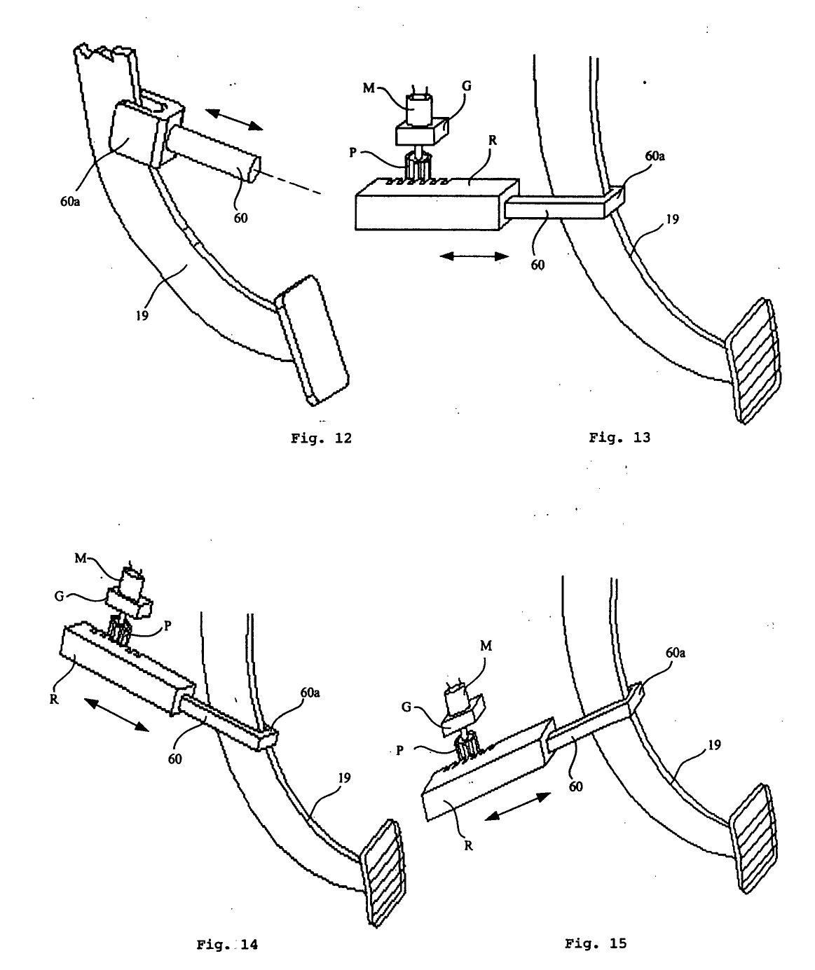

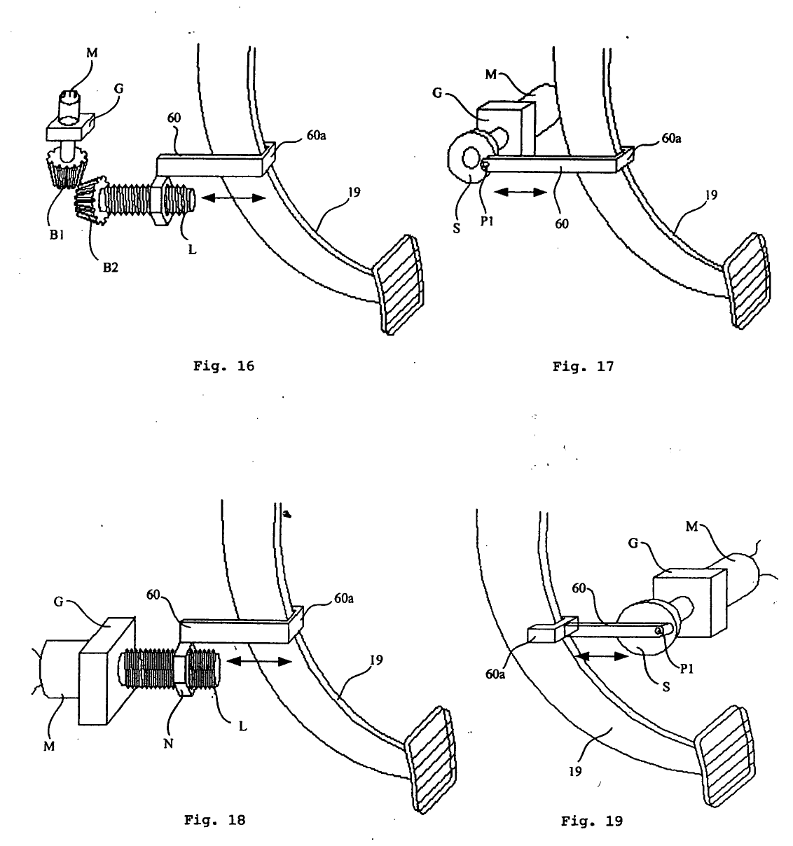

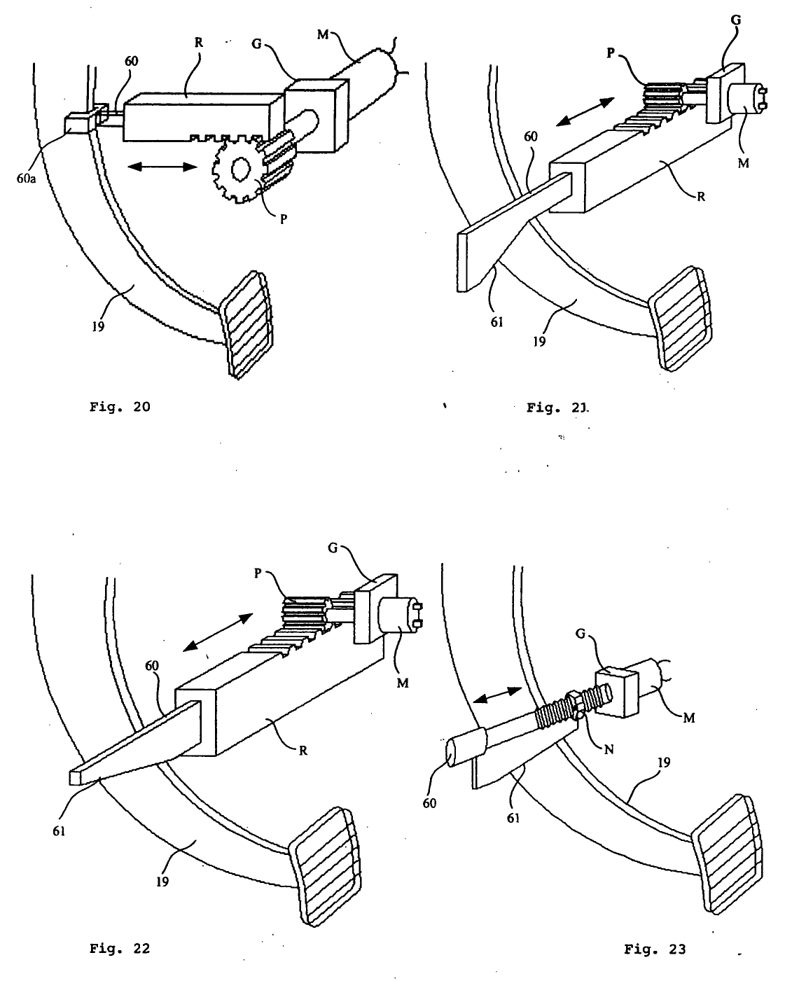

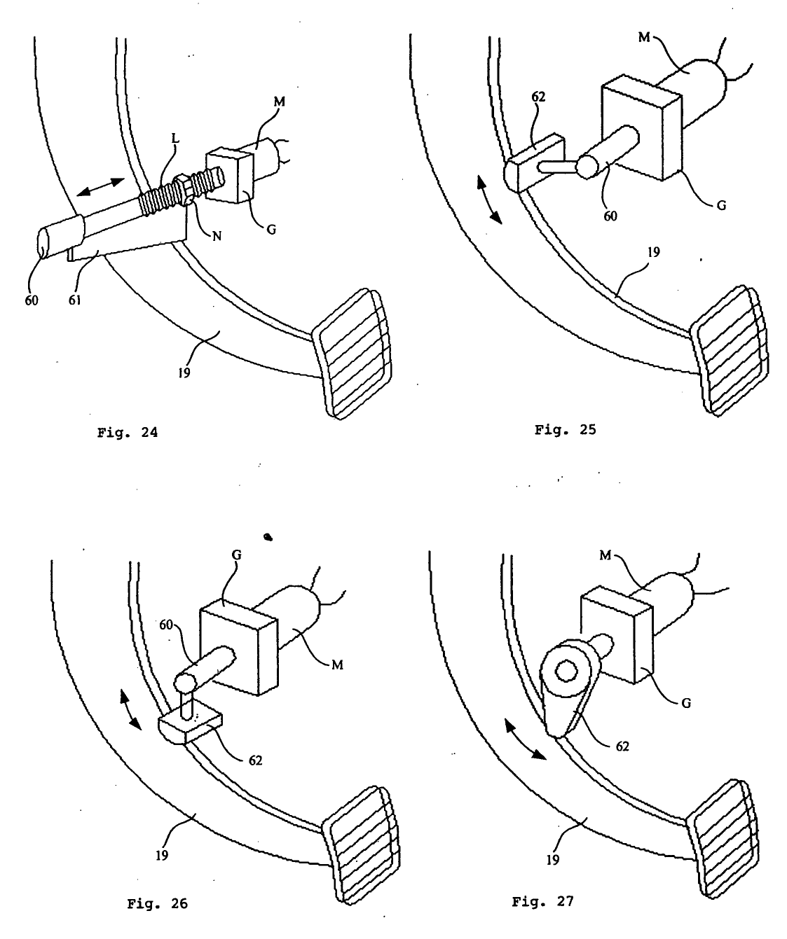

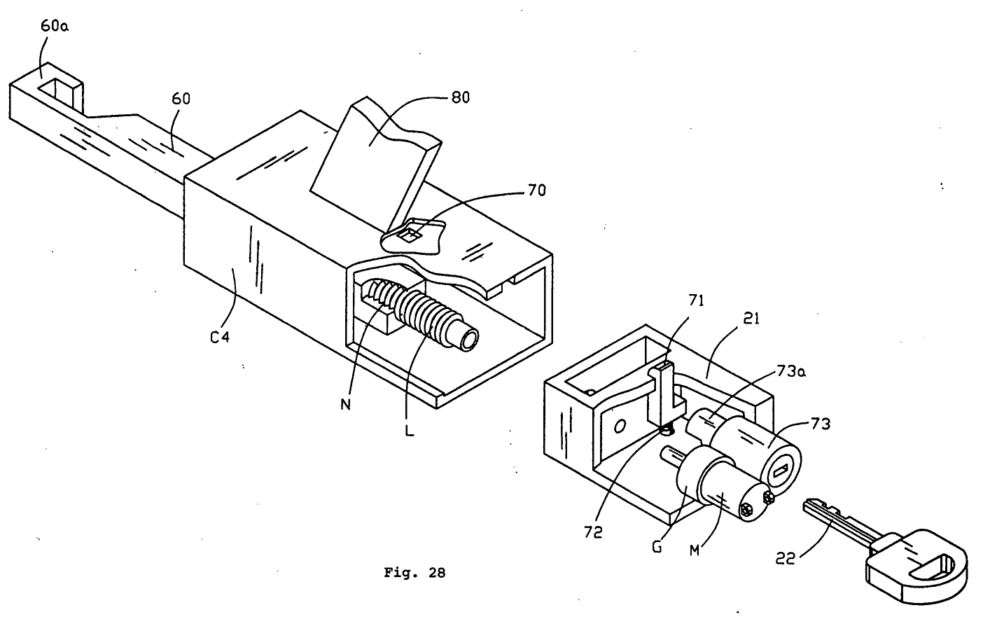

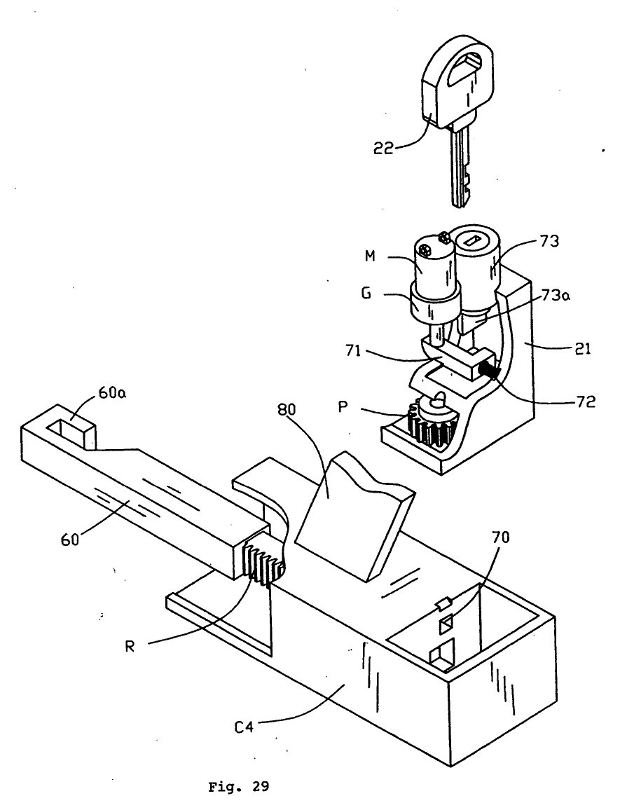

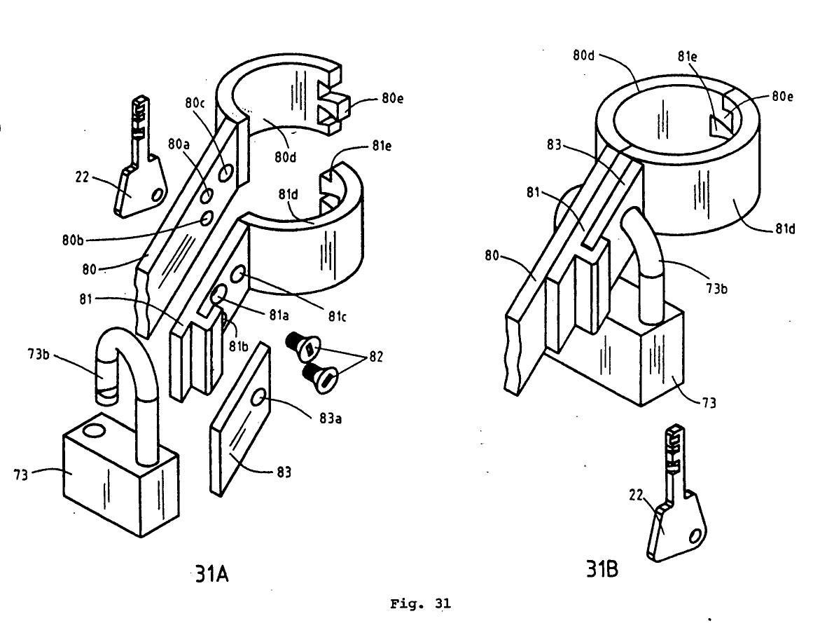

FIG. 8 through FIG. 27 show embodiments of the drive mechanism 18 provided for executing the engagement and releasing of the brake. Such drive mechanism is a mechanism which acts on the brake shaft 19 to engage the brake, or it can be a mechanism which acts on any parts of the brake system until the brake shaft 52 move to engage the brake (not showing). In addition, the drive mechanism 18 also has different embodiments and methods of operation, depending on the structure of each type and model of automobiles or structure of each type of vehicle. The figures showing embodiments of the drive mechanism in this specification of invention are examples of embodiments of the drive mechanism 18 which are not intended to limit the scope of the present invention. Although the embodiment of the drive mechanism may differ from the exemplary embodiment appeared in this specification of invention, an electrical-electronic circuit according to the present invention can be applied to control the operation of the motor which moves the drive mechanism to engage or release the brake of automobiles or other types of vehicles. Such application is considered to be within the scope of the present invention.

The electrical-electronic circuit according to the present invention means a circuit within the main control circuit C2 and the main instruction section C3, including the decoder circuit D1, drive circuit 16, control circuit 17, brake engaged and released state detection circuit 20 encased in the casing C4, antenna coil 6, and TAG 7. When such circuits are brought to work together, the system will be able to control the operation of the motor to move the drive mechanism to engage or release the brake. In order to facilitate the understanding of the drive mechanism 18 according to the present invention, an example in FIG. 28 and FIG. 29 is used in conjunction with the explanation below.

FIG. 28 shows an exemplary embodiment of the present invention which is provided with a drive mechanism 18 comprising at least a lead screw L having one end inserted to rotation axle of the motor M (including reduction gear box G) and the other end inserted in a nut N of the braking member 60. The end 60a of the braking member is designed to fit with the brake shaft 19 so that the rotation of the motor will make the lead screw L rotate and follow, causing the braking member 60 to move and act upon the brake shaft 19 to engage or release the brake. FIG. 29 shows another exemplary embodiment of the present invention which is provided with a drive mechanism 18 comprising at least a pinion P mounted to the rotation shaft of the motor M (including reduction gear box G) and at the same time engaging with the rack R, with one end of the rack connected to the braking member 60. The end 60a of the braking member 60 is designed to fit with the brake shaft 19 so that the rotation of the motor will make the pinion P rotate and drive the rack R to move and carry the brake member 60 to act upon the brake shaft 19 in order to engage or release the brake.

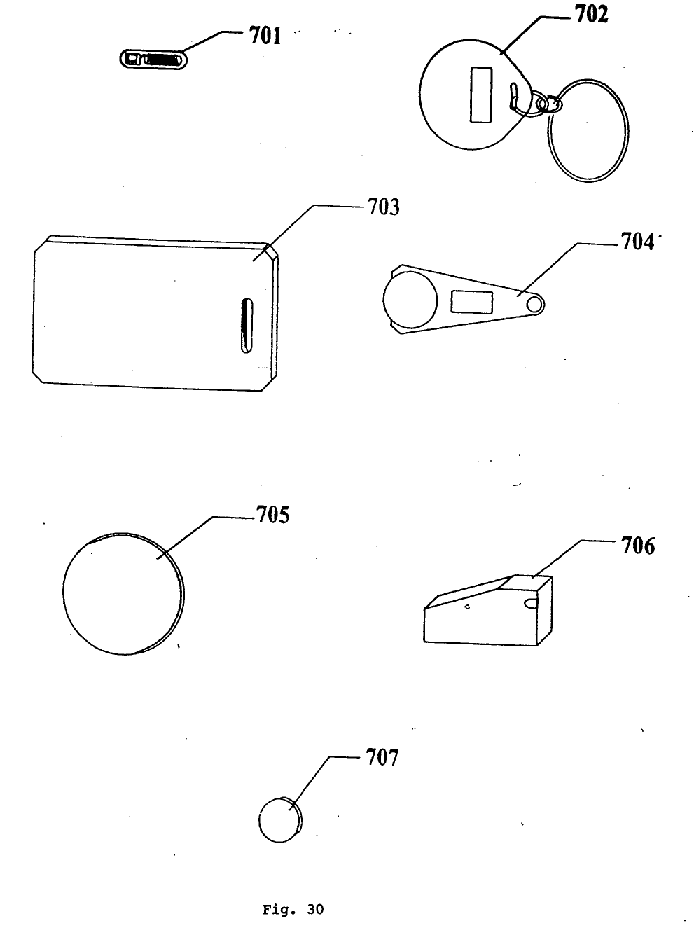

According to the present invention, the braking member 60 is a member provided for engaging or releasing the brake. One end 60a of this member is designed to fit with the brake shaft 19 (as shown in FIG. 8 through FIG. 20 including FIG. 28 and FIG. 29), or at the end of this member a slope can be provided as indicated by reference number 61 (as shown in FIG. 21 through FIG. 24), or at the end of this member can be provided with a brake presser 62 connected together (as shown in FIG. 25 through FIG. 27), the rotation of the motor M will make the braking member 60 move and act upon the brake shaft 19 in order to engage or release the brake.

And in addition to the description given above in FIG. 28 and FIG. 29, it can be seen that there is one more important part of the present invention incorporated. This important component is a lock release mechanism 21 which includes at least a master lock 73, a lock latch 71 and spring 72 component assembled to work together with the motor M, and an electrical-electronic circuit of the braking operation section C1 (not shown) and then encased in the casing C4 which is attached to the attachment member 80 provided for attaching the braking operation section according to the present invention to the cylinder covering the steering wheel shaft, or the brake system attachment base 51, or the vicinity of the cylinder covering the steering wheel shaft, or the vicinity of the brake system attachment base. Thus, if the drive mechanism 18, motor M, or electrical-electronic circuit of the present invention does not function, the owner of the automobile can still use the key 22 to unlock the master lock 73 of the lock release mechanism 21 in order to make the cam shaft 73a of the master lock act upon the lock latch 71 until the force of spring 72 is overcome. This causes the lock latch to move out of the locking groove 70 and enable the owner of the automobile to remove the lock release mechanism 21, motor M, parts or all of the drive mechanism 18 out of the structure of the casing C4 and thereby free the brake system of the automobile from the drive mechanism 18 and returning the brake system back to a normal working condition.

FIG. 31 through FIG. 33 shows a structure for attaching the braking operation section C1 in the area near the cylinder covering the steering wheel shaft and the area on the brake system attachment base 51 respectively. According to the figures it can be seen that by assembling the lock release mechanism 21 with the motor M, drive mechanism 18 and the electrical-electronic circuit in the braking operation section C1 and then encasing these components within the casing C4 as shown in FIG. 28 and FIG. 29, the device of the present invention can still allow the lock release mechanism to be assembled to the attachment member 80 connected to the casing C4 (such lock release mechanism is inside the casing C4), this is considered to be within the scope of the present invention.

FIG. 31 shows an embodiment of the structure for attaching the braking operation section C1 encased in the casing C4 of the present invention to the cylinder covering the steering wheel shaft, and assembled of the lock release mechanism 21 to the structure for attachment. These structures for attachment in the figures include at least an attachment member 80 provided for mounting to the cylinder covering the steering wheel shaft, with one end connected to the casing C4 (not shown). The end 80d of the attachment member 80 is curved to fit with the cylinder covering the steering wheel shaft and has a spline 80e for engaging with the spline 81e of the attachment leg 81. This attachment leg has an end 81d designed with a curve to fit with the cylinder covering the steering wheel shaft and is also curved to fit with the end 80d of the attachment member 80. Assembly of these parts can be achieved by bringing both members to assemble together in order to install on the cylinder covering the steering wheel shaft as show in FIG. 31b and then insert the screw 82 through the hole 81a and 81b of the attachment leg 81 and further insert through the through hole 80a and 80b of the attachment member 80 and then tightening this screw (screw 82 can be an ordinary screw for general purpose of dead lock screw. All considered to be within the scope of the present invention.) The screw cover plate 83 can then be assembled to the attachment leg 81 by aligning the hole 83a of the screw cover plate to the hole 81c of the attachment leg 81. This screw cover plate then covers the screw head 82 completely in order to prevent any attempt to unscrew the screw out. The lock release mechanism 21 comprising at least a lock shaft 73b of the master lock 73 can then be assembled together with the components of the structure mentioned above by inserting the lock shaft 73b into the through hole 83a, hole 81c, and hole 80c respectively and then engage the master lock.

FIG. 32 shows another embodiment of the structure for the attachment for the braking operation section C1 which is encased in the casing C4 of the present invention unto the brake system attachment base 51. The figure also shows an assembly of the lock release mechanism 21 unto the structure for the attachment. This structure for attachment in the figure comprises at least an attachment member 80 provided for attaching to the brake system attachment member 80 provided for attaching to the brake system attachment base 51 of the automobile, with one end connected to the casing C4 (not shown) and the other end connected with the flange 91. Flange 91 has a hole 91a at least one hole for inserting a female screw 51a of the brake system of the automobile (see FIG. 1) when the attachment member 80 which is connected to the flange 91 is attached to the brake system attachment base 51 and then the female screw 51b is tightened to force the attachment member into close contact with the brake system attachment base 51, a screw cover plate 92 can then be brought to cover on top of the flange 91 with a curved end 92c engaged on an end 91b of the flange 91. In this case the hole 92a and the hole 92b of the screw cover plate is aligned to the hole 90a and the hole 90b of the attachment member 80 respectively. At least one screw 82 can then be inserted into the hole 92 and hole 90a and tightened to complete the assembly.

The lock release mechanism 21 can then be assembled to the components of the structure for the attachments mentioned above, this lock release mechanism comprises at least a master lock 73 with a notch 73g for melting the attachment member 80 and the screw cover plate 92 to prevent the two parts from moving away from each other. After the master lock, 73 are assembled with the two parts as shown in FIG. 32B, the lock shaft 73b can then be inserted into the hole 73c of the master lock and passed through the hole 92b of the screw cover plate 92 and then passed through the hole 90b of the attachment member 80 and then penetrating into the hole 73d of the master lock respectively. Completion of such operation causes the master lock 73 to be in a lock state.

FIG. 33 shows another embodiment of the structure for attaching the braking operation section C1 encased in the casing C4 of the present invention to the brake system attachment base 51 and also shows the assembly of the lock release mechanism 21 with the structure for attachments mentioned. The structure for attachments shown in the figure comprises at least an attachment member 80 provided for attaching to the brake system attachment base 51 of the automobile, with one end connected to the casing C4 (not shown) and the other end connected to the flange 91. Flange 91 has a hole 91a at least one hole for inserting a female screw 51a of the automobile brake system (see FIG. 1). The lock release mechanism 21 comprises at least a master lock 73 with its body connected to the groove 92d of the screw cover plate 92. The code mechanism of the master lock and the cam shaft 73a is inserted into the hole 73e of the master lock. The end region of the cam shaft 73a is provided with a locking member 73f for inserting into the hole 91c of the flange 91 for locking the screw cover plate 92 to the flange 91 in order to prevent the pieces from moving away from each other.

An assembly can be achieved by bringing the attachment member 80 connected to the flange 91 into attachment with the brake system attachment base 51 and then tightened the female screw 51b in order to force the attachment member to come in close contact with the brake system attachment base 51 of the automobile. A screw cover plate 92 can then be assembled to the attachment member 80 with the curved end 92c engaged to the end 91b of the flange 91 and with the hole 92b of the screw cover plate aligned to the hole 90b of the attachment member 80 respectively. At the same time the locking member 73f of the master lock 73 is inserted into the groove 91c of the flange 91 as shown in the FIG. 33B. A key 22 can then be used to unlock the master lock 73 to force the locking member 73f to engage with the groove 91c of the flange 91 in a locking manner as shown in FIG. 33C in order to force the screw cover plate 92 to be tightly attached to the flange 91. In addition, the screw cover plate 92 and the attachment member 80 also have a hole 92b and hole 90b respectively for bringing another set of master lock into a locking position to further enhance the power of theft prevention.

In FIG. 31 it can be seen that when the motor of the electrical-electronic circuit (not shown) including the drive mechanism of the present invention do not function, the owner of the automobile can still use the key 22 to unlock the master lock 73 of the lock release mechanism 21 and then pull out the lock shaft 73b from the hole 80c, hole 81c, and hole 83a respectively. This makes it possible to remove the master lock 73 from the assembly and enables the removal of the screw cover plate 83 and then unscrewing of the screw 82 out in order to move the attachment leg 81 from the cylinder covering the steering wheel shaft. Some parts or the whole of the braking operation section C1 including the casing C4 can then be removed and enable the brake system of the automobile to operate normally. In FIG. 32, it can be seen if the owner of the automobile uses a key 22 to unlock the master lock 73 of the lock release mechanism 21 and then pull out the lock shaft 73b out from the hole 73d, hole 90b, hole 92b, and hole 73c respectively, the master lock 73 can then be removed from the assembly and thus making it possible to unscrew the screw 82 out from removing the screw cover plate 92 from the flange 91 and further unscrew the female screw 51b to remove the flange 91 from the brake system attachment base 51 of the automobile. Some parts or the whole of the

braking operation section C1 including the casing C4 can then be removed in order to allow the brake system of the automobile to operate normally. In FIG. 33, it can be seen that if the motor or electrical-electronic circuit (not shown) including the drive mechanism of the present invention do not function, the owner of the automobile can still use the key 22 to unlock the master lock 73 of the lock release mechanism 21 in order to force the locking member 73 out of the engagement with the groove 91c of the flange 91 in an unlocking manner shown in FIG. 33C. This enables the removal of the screw cover plate 92 and unscrewing of the female screw 51b in order to remove the flange 91 from the brake system attachment 51 of the automobile. Some parts or the whole of the braking operation section C1 including the casing C4 can then be removed from the brake system attachment base of the automobile too.

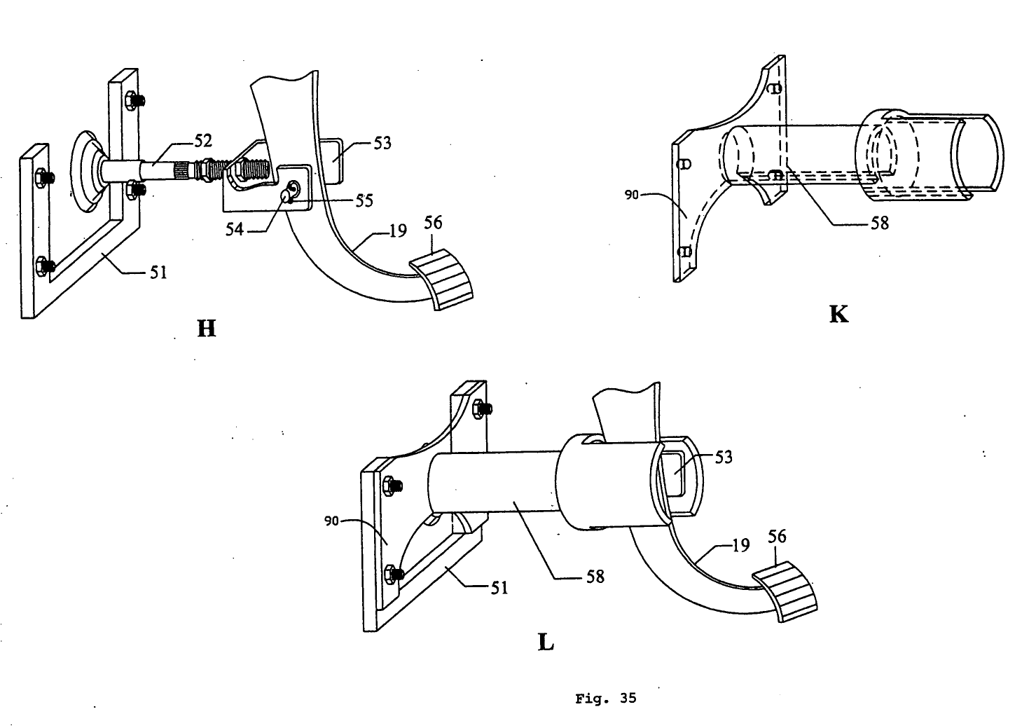

The device for electrically locking the brake of an automobile according to the present invention also provides a cover cylinder 57 or cover cylinder 58 which is made of metal for encasing the brake shaft 52 as shown in FIG. 34 and FIG. 35 to ensure the user of the device for locking the brake of the automobile according to the present invention that the brake system of the automobile will not be easily destroyed. The cover cylinder 57 or cover cylinder 58 will cover the brake shaft 52, U-shape attachment frame 53, latch shaft 54, and lock pin 55. This cover cylinder has an attachment base 90 for securedly attaching to the brake system attachment base 51 or in the vicinity of the cover cylinder. This makes it impossible for thieves to destroy the brake system by cutting or using a saw to cut off the brake shaft 52, U-shape attachment frame 53, or remove the latch shaft 54, and lock 55.

The cover cylinder 57 as shown in FIG. 34 and the cover cylinder 58 as shown in FIG. 35 is only an example for an easy explanation of the invention and is not intended to limit the scope of the present invention. Such cover cylinders may have a different feature than what is shown in the figures, such as a cover cylinder which protrudes out from the casing C4 in order to cover the brake system of the automobile, depending on the structure of the brake system of each type or model of automobiles or vehicles. The cover cylinder mentioned above is intended to prevent thieves from cutting or sawing or using any other means to destroy the brake system of the automobile. Any change or modification in the features of the cover cylinder mentioned is not considered from departing from the scope of the present invention.

Any improvement or modification conceivable by persons of ordinary skills in the arts are considered to be within the scope of the present invention which is explained and specified in the claims attached to the specification.

### BEST MODE OF INVENTION

As described in the Detailed Description of the invention.

1. A device for electrically locking brake of an automobile, characterized in comprising:
A braking operation section c1 for engaging and releasing the brake, the braking operation section being encased in a casing made from metal solidly for preventing destruction or changes of connections of electrical-electronic circuit, including preventing destruction of internal components of devices, the braking operation section including the casing being solidly installed with a structure for attaching to the brake system attachment base of the automobile or attaching to the cylinder covering the steering wheel shaft of automobile or the vicinity thereof
The braking operation section comprising at least a decoder circuit D1 for comparing a code signal received with a predetermined code for matching; sending a signal to the driver circuit for further operation if the code signal is correct, a drive circuit 16 for amplify8ing and formatting signals into an appropriate form used to control the operation of the motor, a control circuit 17 for controlling the operation of the drive circuit and the motor, a motor M (including a reduction gear box) for functioning as a power source in controlling the operation of the driving mechanism, a driving mechanism 18 for acting on the brake system in order to engage or release the brake, a brake engaged and released state detection circuit 20 for checking the state of the brake system whether it is in a fully engaged or fully released or not at that moment, and a lock release mechanism 21 for allowing a key to be used to make the brake system of the automobile able to work normally in case the motor, the driving mechanism, or electrical-electronic circuit do not function normally, and
A main control section C2 for controlling major operations of the device for electrically locking the brake of a automobile, including at least a micro-controller 30 for controlling and instructing device for electrically locking the brake of a automobile to operate, a drive circuit for amplifying and formatting signals into an appropriate form for operation in each function, an encoder circuit E1 for receiving signals from the microcontroller and then creating a signal as a code for sending to the braking operation section so as to operate according to the instruction received, a decoder circuit for comparing the code signal received whether the code signal matches a predetermined code or not and sending signals to other components to operate if the code signal is correct, a band pass circuit 15 for filtering and adjusting signals received into a complete form, a buffer circuit for adjusting signals into an appropriate before sending to the microcontroller for processing and further execution, and a memory unit 29 for storing operation data including storing programs for controlling operations of various components of the device for electrically locking the brake of an automobile,
An instruction section C3 for setting the system into a ready mode (ARM) or canceling the ready mode of the system (DISARM) comprising at least a switch or device for closing or opening the circuit so as to set the system into a ready mode or canceling the ready mode of the system, an encoder circuit E3 for creating a signal as a code for sending to the controlling section for further operation,
An antenna coil 6 for distributing frequency wave energy for supplying energy to TAG into the air and receiving ID code signal mixed with radio waves for sending to the main control section,
A TAG 7 for receiving energy from the antenna coil and generating energy for itself until it is able to create an ID code and mixing with the radio waves within itself and send the code signal back to the antenna coil which, upon receiving the signal, will send a signal to the main control section for processing in order to reset and cancel all operations of the device for electrically locking the brake of an automobile and return the system back to normal operating condition, thereby bringing the brake system of the automobile back to normal operating condition, and
A key 22 having a specific feature for unlocking the master lock in order to remove some parts or the entire braking operation section from the metal casing, or to remove some components or the entire braking operation section including the metal casing from components of the structure for attaching to the brake system attachment base of the automobile, or to remove from components of the structure for attaching to the cylinder covering the steering wheel shaft, or the vicinity thereof.

2. A device for electrically locking the brake of an automobile according to claim 1, further comprising means for controlling the operation of theft prevention signal and/or means for inhibiting the operation of the electrical system for starting the engine of the automobile and/or means for controlling the operation of the engine such as fuel supply system, operating system of the ECU (Engine Control Unit), and/or means for controlling the operation of light bulb of the automobile so as to generate flashing to alert and attract attentions of people nearby, and/or means for controlling other parts of the automobile which disable movements of the automobile, and/or a system for informing the owner of automobile, persons, organizations concerned, of the abnormal situation occurring at the automobile by sending radio waves to a radio wave receiving circuit carried by the owner of automobile, and/or means for making a telephone call to a predetermined telephone number, and/or means for informing the situation by other means of communication.

3. A device for electrically locking the brake of an automobile according to claim 1, wherein setting the system into a ready mode (ARM) or canceling the reading mode of the system (DISARM) or resetting and canceling all operations of the device for electrically locking the brake of an automobile back to normal condition requires an encoding process using such method as encoding by ordinary electronic circuits, encoding by an encoding integrated circuit, encoding using biometrics system such as using face image, retina scan, bio-finger printing, etc., using smart cards, using cards with unique bare code, using smart card type citizen ID card, or other means of encoding which enables the main control section to carry out processing and instruction to related components in order to set the system into the ready mode or cancel the ready mode of the system or reset and cancel all operations of the device for electrically locking the brake of an automobile and return back to normal operating condition, from which any of the encoding methods or a combination thereof can be used.

4. A device for electrically locking the brake of an automobile according to claim 1, wherein the transmission of code signal for setting the system into a ready mode (ARM) or canceling the system from the ready mode (DISARM) or sending a code signal for resetting and canceling all operations of the device for electrically locking the brake of an automobile and return back to normal operating condition to the main control section is a transmission of code signal using a wired or wireless remote controls system such as optical transmission, radio frequency transmission, telephone signal transmission, or other means of remote control system capable of allowing the decoder circuit in the main control section to receive the code signal and compare with a predetermined code signal so that the main control section can carry out processing and issue instructions to related components to carry out executions according to the code signal received.

5. A device for electrically locking the brake of an automobile according to claim 1, wherein the driving mechanism which acts on any part related to the brake system of the automobile in order to engage or release the brake has a motor as a power source for driving the mechanism.

6. A device for electrically locking the brake of an automobile according to claim 1, further applicable to various type of vehicles other than automobiles by using a motor and driving mechanism designed for use with that particular type of the brake system of the vehicle.

7. A device for electrically locking the brake of an automobile according to claim 1, wherein the motor and driving mechanism have other features designed for use with each type and model of automobiles and vehicles which can work together the electrical-electronic circuit of the present invention.

8. A device for electrically locking the brake of an automobile according to claim 1, wherein the motor or parts or the entire lock release mechanism and driving mechanism and electrical-electronic circuit of the braking operation section are encased in another layer of metal casing for preventing destruction of components and mechanism or devices inside, including preventing tampering of the connections of the electrical-electronic circuit.

9. A device for electrically locking the brake of an automobile according to claim 1, wherein if the motor or driving mechanism or electrical-electronic circuit cannot be used, a key can be used to unlock in order to remove the motor and/or parts or the entire driving mechanism and lock release mechanism and/or electrical-electronic circuit of the braking operation section C1 from the casing C4 which is made from metal in order to return the brake system of the automobile back to normal operating condition,
If the motor or driving mechanism or electrical-electronic circuit cannot be used, the a key can be used to unlock and remove the motor and/or parts or the entire driving mechanism and lock release mechanism and/or the electrical-electronic circuit of the braking operation section to remove from the components of the structure for attaching the brake system attachment base of the automobile, or remove from the components of the structure for attaching the cylinder for covering the steering wheel shaft or in the vicinity thereof in order to return the brake system of the automobile back to normal working condition.

10. A device for electrically locking the brake of an automobile according to claim 1, further including a cover cylinder 57 and cover cylinder 58 made from metal for encasing the brake shaft and parts or the entire structure related to the brake system in order to prevent destruction of any parts of the brake system and render the device for electrically locking the brake of an automobile unable to prevent any stealing.

11. A device for electrically locking the brake of an automobile according to claim 1, wherein after the microcontroller has received a signal to cancel the operation of the system from the ready mode (DISARM) or a signal to reset and cancel all operations, when there is a signal indicating the operation of the engine coming into input terminal of the microcontroller, the microcontroller will carry out a processing and instruct the device for electrically locking the brake of an automobile not to do any thing in order to prevent any possible accidents while driving the automobile.

12. A device for electrically locking the brake of an automobile according to claim, wherein the microcontroller and memory unit will record the latest operating state before the electrical current feeding the electrical-electronic circuit stop flowing, and the microcontroller will carry out a processing and issue instruction to related components to operate according to the latest operating state before the electrical current feeding the electrical-electronic circuit stops flowing when there is an electrical current flowing into the circuit again.

13. A device for electrically locking the brake of an automobile according to claim 1, wherein the encoder circuit E1, decoder circuit D2, decoder circuit D3, and memory unit 29 of the main control section can be incorporated inside the microcontroller.

14. A device for electrically locking the brake of an automobile according to claim 1, wherein the driving mechanism will employ an actuator A for execution of the engagement or release of the brake, said actuator comprising at least a motor M (including reduction gear box G), lead screw L with one end provided with a hole for mounting the rotation shaft of the motor, and a braking member 60 with one end provided with a nut N for inserting the lead screw L and having an end 60a designed to fit with the brake shaft 19.

15. A device for electrically locking the brake of an automobile according claim 1, wherein the driving mechanism comprises at least a pinion P mounted to the rotation shaft of the motor and at the same time engaged to the rack R with one end of the rack connected to the braking member 60 which has an end 60a designed to fit with the brake shaft 19.

16. A device for electrically locking the brake of an automobile according to claim 1, wherein the driving mechanism comprises at least a bevel gear B1 mounted to the rotation shaft of the motor, a bevel gear B2 attached to the lead screw L which is inserted into the nut N connected to the braking member 60 having the end 60a designed to fit with the brake shaft 19.

17. A device for electrically locking the brake of an automobile according to claim 1, where in the driving mechanism comprises at least a cam set S mounted to the rotation shaft of the motor, the cam set being provided with a joint P1 for mounting to the braking member 60 with one end 60a designed to conform with the brake shaft 19.

18. A device for electrically locking the brake of an automobile according to the claim 1, wherein the driving mechanism comprises at least a lead screw L mounted to the rotation shaft of the motor and a braking member 60 with one end connected to the nut N for inserting the lead screw L and an end 60a designed to fit with the brake shaft 19.

19. A device for electrically locking the brake of an automobile according to claim 1, wherein the driving mechanism comprises at least a lead screw L having one end provided with a hole for inserting the rotation shaft of the motor, and a braking member 60 provided with a nut N for inserting the lead screw L and one end 60a of the braking member being designed to fit the brake shaft 19.

20. A device for electrically locking the brake of an automobile according to claim 1, wherein the lock release mechanism comprises at least a master lock 73, lock latch 71, and spring 72 in an assembly to work with the motor and driving mechanism and encased in the casing C4 which is attached to the attachment member 80 provided for attaching to the cylinder covering the steering wheel shaft of the automobile or the brake system attachment base 51 of the automobile or the vicinity of the cylinder covering the steering wheel shaft or the vicinity of the brake system attachment base.

21. A device for electrically locking the brake of an automobile according to claim 1, wherein the structure for attaching the braking operation section C1 encased in the casing C4 to the cylinder covering the steering wheel shaft of an automobile comprises at least an attachment member 80 provided to be mounted to the cylinder covering the steering wheel shaft, with one end connected to the casing C4 and the end 80d of the attachment member 80 being curved to fit with the cylinder covering the steering wheel shaft of the automobile and having a spline 80e for engaging with a spline 81e of the attachment leg 81, the attachment let having an end 81d designed with a curvature to fit the cylinder covering the steering wheel shaft of the automobile and also curved to fit with the end 80d of the attachment leg 80,
Wherein an assembly can be achieved by assembling both members to the components of the structure for attachment and then inserting a screw 82 through the hole 81a and 81b of the attachment leg 81 and further inserting through a hole 80a and hole 80b of the attachment member 80 and then tightening the screw, bringing a screw cover plate 83 to assemble with the attachment leg 81 by aligning the hole 83a of the screw cover plate to the hole 81c of the attachment leg 81 so that the screw cover plate completely covers the screw head 82 of both screws to prevent unscrewing out, bringing a lock release mechanism 21 which includes at least a lock latch 73b of the master lock 73 to assemble with the attachment member by inserting the lock shaft 73b through the hole 83a, hole 81c, and hole 80c respectively and then locking the master lock.

22. A device for electrically locking the brake of an automobile according to claim 1, wherein the structure for attaching the braking operation section C1 encased in the casing C4 to the brake system attachment base of the automobile comprises at least an attachment member 80 provided for attaching to the brake system attachment base 51 of the automobile with one end being connected to the casing C4 and the other end connected to a flange 91 having at least one hole 91a for inserting a male screw 51a of the brake system of the automobile, an assembly being achieved by bringing the attachment member connected to the flange 91 to install on the brake system attachment base of the automobile and tightening the nut 51b then bringing the screw cover plate 92 to assemble and cover the flange 91 with a curved end 92c being engaged with the end 91b of the flange 91 and with the hole 92a and hole 92b of the screw cover plate being aligned to the hole 90a and hole 90b of the attachment member 80 respectively, then bringing at least one screw 82 to insert through the hole 92a and 90a and then tighten the screw.
Wherein the lock release mechanism is assembled to the components of the structure for attachment, the lock release mechanism includes at least a master lock 73 having a notch 73g for mounting the attachment member 80 and a screw cover plate 92 for preventing both components from moving away from each other, wherein the assembly is achieved by bringing the master lock 73 to assemble with both components and bring the lock shaft 73b to insert through 73c of the master lock, further insert through hole 92b of the screw cover plate 92 and through hole 90b of the attachment member 80 and penetrating into the hole 73d of the master lock respectively in order to execute the locking.

23. A device for electrically locking the brake of an automobile according to claim 1, wherein the structure for attaching the braking operation section C1 encased in the casing C4 to the brake system attachment base of the automobile includes at least an attachment member 80 provided for attaching to the brake system attachment base of the automobile with one end being connected the casing C4 and the other end connected to the flange 91 having a hole 91a at lease one hole for inserting a male screw 51a of the brake system of the automobile, hole 90b for bringing another set of master lock to engage in order to further prevent stealing, and a groove 91c for inserting the locking member 73f of the master lock 73 in order to force the screw cover plate 92 to be tightly attached to the flange 91, and
A screw cover plate 92 which is provided with a lock release mechanism comprising at least a master lock 73 having its body connected to the groove 92d, wherein the code mechanism system of the key and the cam shaft 73a are inserted into the hole 73e of the master lock, the screw cover plate 92 being further provided with a curved end 92c for engaging the end 91b of the flange 91 and provided with a hole 92b for bringing another set of master lock into locking position to further prevent stealing as another layer of security.
